(19) United States
(12) Patent Application Publication
(10) Pub. No.: US 2006/0067300 A1
(43) Pub. Date: Mar. 30, 2006

(54) System and method for bridge call appearance in distributed peer-to-peer network

(76) Inventors: Behrouz Poustchi, City Kanata (CA); Tu Do, City Kanata (CA)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 10/953,039

(22) Filed: Sep. 30, 2004

(51) Int. Cl. H04L 12/66

(52) U.S. Cl. 370/352

(57) ABSTRACT

A Bridge Call Appearance (BCA) Group including a plurality of peer-to-peer packet-based devices and methods for operating the BCA Group are provided by embodiments of the present invention. In the BCA Group at least one peer-to-peer packet-based device is designated as a primary device and remaining peer-to-peer packet-based devices are designated as secondary devices. An example of such a system is an office environment including a boss's terminal set designated as a primary device and the boss's assistant's terminal sets designated as secondary devices. The secondary devices provide support for the primary device when the primary device is unavailable. The primary network device acts as an intermediary for protocol signaling involving a secondary network device and an other device with which the secondary network device is communicating. Examples of call processing features used in the BCA Group environment are answering incoming calls, placing outgoing calls, placing a call on hold, retrieving a call from hold, performing a blind transfer, and performing an attended transfer.

### FIELD OF THE INVENTION

The invention relates to distributed peer-to-peer networks, and in particular to call processing features handled by such networks.

### BACKGROUND OF THE INVENTION

Some modern communications solutions are based on VoIP (Voice-over IP (Internet Protocol)) technology, which involves the transmission of calls over a data network based on the IP. The communication is in the form of packet data and thus there is no fixed connection as there would be in the case of switched networks. The communication can be text, voice, graphics or video. In order to simplify IP communication problems, standards have been developed and adopted in the industry. Examples of such standards are H.323 (Packet based communication systems) and SIP (Session Initiation protocol). These standards are followed when designing new hardware and software. The SIP standard covers the technical requirements to set-up, modify and tear down multimedia sessions over the Internet. A multimedia communication session between two endpoints will be referred to as a call.

In conventional local telephone networks, for example an office environment, a central location such as a main switchboard or public exchange (PBX) controls routing of incoming calls, holds placed by extensions of the local telephone network, transferring of calls, etc. This type of call management has several disadvantages. For example the central location is responsible for overseeing and maintaining control of all traffic in the network. This results in the need for significant processing capability to reside in one location.

In the office environment example above call processing features such as placing a call on hold, retrieving a call from hold, blind or attended transfers are ultimately handled by the switchboard or PBX. When a call is placed on hold by a terminal, the call is held by the switchboard. When a call is transferred to another extension, the call is routed through the switchboard. This is the reason the switchboard needs to have significant processing capability. For an office of tens to hundreds of people the switchboard must be capable of handling multiple holds, transfers, etc. while still routing regular incoming and outgoing traffic

To ensure that a maximum load can be handled by the switchboard or PBX it is necessary to have more processing capability than is generally required at any given time. This results in a waste of processing capability at the expense of the customer using the local network.

In addition, with conventional systems communication and control protocol between a typical PBX and phone sets are proprietary. Therefore, customers are usually forced to buy PBX and phone sets from the same vendor. Furthermore, in a traditional PBX system, phone sets are usually “dumb”, all the intelligence and processing power are placed in the centralized PBX/Call Server, hence the up-front entry cost for a small system is high.

Scalability is another disadvantage of traditional PBX systems, as they typically have limited capacity, beyond which a significant upgrade would be required.

### SUMMARY OF THE INVENTION

According to a first broad aspect of the present invention, there is provided a Bridge Call Appearance (BCA) Group comprising a plurality of interconnected peer-to-peer packet-based network devices adapted to collectively implement BCA call processing features in a distributed manner.

In an embodiment of the first aspect, the BCA call processing features comprise at least one of a group consisting of answering incoming calls, placing outgoing calls, placing a call on hold, retrieving a call from hold, performing a blind transfer, and performing an attended transfer.

In an embodiment of the first aspect, at least one peer-to-peer packet-based network device of the plurality of interconnected peer-to-peer packet-based network devices is designated as a primary network device and remaining peer-to-peer packet-based network devices are designated as secondary network devices, the secondary network devices adapted to provide support for the primary network device when the primary network device is unavailable, wherein the primary network device is adapted to act as an intermediary for protocol signalling involving a secondary network device in the BCA Group and an other device with which the secondary network device in the BCA Group is communicating.

In an embodiment of the first aspect, communication data is exchanged between the secondary network device in the BCA Group and the other device subsequent to establishing a network device-to-device connection, the primary network device remaining in contact with the secondary network device and the other network device to facilitate further protocol signaling as the intermediary between the network device in the BCA Group and the other device.

In an embodiment of the first aspect, communication data flows between the secondary network device in the BCA Group and the other device subsequent to establishing a network device-to-device connection in accordance with Real-time Transport Protocol (RTP).

In an embodiment of the first aspect, protocol signaling is performed in accordance with Session Initiation Protocol (SIP).

In an embodiment of the first aspect, the other device is a peer-to-peer packet-based network device internal to the BCA Group.

In an embodiment of the first aspect, the other device is external to the BCA Group.

In an embodiment of the first aspect, the primary network device and the secondary network devices are Voice over Internet Protocol (VoIP) telephone terminal sets.

In an embodiment of the first aspect, the primary network device and the secondary network devices are packet-based communication telephone terminal sets.

In an embodiment of the first aspect, the primary network device is designated as a secondary network device for a second primary network device in the BCA Group.

In an embodiment of the first aspect, the primary network device is assigned at least one backup primary network device and when the primary network device is not connected within the BCA Group, the at least one backup primary network device performs tasks that the primary network device would have performed if the primary network device was connected within the BCA Group.

According to a second broad aspect of the present invention, there is provided a peer-to-peer system comprising at least one BCA Group according to the first broad aspect, wherein at least one peer-to-peer packet-based network device is designated as a primary network device and remaining peer-to-peer packet-based network devices are designated as secondary network devices, the secondary network devices adapted to provide support for the primary network device when the primary network device is unavailable, and at least one access interface coupled to the at least one BCA Group, the at least one access interface providing access to communication networks external to the peer-to peer system.

In an embodiment of the second aspect, the at least one access interface is a thin trunk interface (TTI) for connecting peer-to-peer packet-based network devices of the at least one BCA Group to a public switched telephone network (PSTN) external to the peer-to-peer system.

In an embodiment of the second aspect, the at least one access interface is an interface for connecting peer-to-peer packet-based network devices of the at least one BCA Group within the peer-to-peer system to a packet-based network external to the peer-to-peer system.

In an embodiment of the second aspect, the primary network device and the secondary network devices are VoIP terminal sets.

According to a third broad aspect of the present invention, there is provided a method for operation of a BCA Group comprising a plurality of interconnected peer-to-peer packet-based network devices wherein at least one peer-to-peer packet-based network device is designated as a primary network device and remaining peer-to-peer packet-based network devices are designated as secondary network devices, the primary network device adapted to act as an intermediary for protocol signaling involving a secondary network device in the BCA Group and an other device with which the secondary network device in the BCA Group is communicating, the method comprising collectively implementing BCA call processing features in a distributed manner.

In an embodiment of the third aspect, the call processing feature is receiving an incoming call, the method comprising a calling device contacting the primary network device, the primary network device contacting the secondary network devices with notification of contact of the calling device, a first secondary network device responding to the contact of the primary network device, the primary network device arranging a connection between the calling device and the first secondary network device via protocol signaling, upon completion of a communication session over the connection between the calling device and the first secondary network device, terminating contact between the calling device and the primary network device and the primary network device terminating contact with the first secondary network device, and the first secondary network device notifying all network devices that the first secondary network device is currently idle.

In an embodiment of the third aspect, the call processing feature is placing an outgoing call, the method comprising the primary network device contacting the secondary network devices prior to contacting a called device to notify the secondary network devices of a possible communication session between the primary network device and the called device, the primary network device contacting the called device, the called device responding to the contact of the primary network device, the primary network device arranging a connection between the called device and the primary network device via protocol signaling, the primary network device contacting the secondary network devices to notify the secondary network devices that the primary network device is currently busy, upon completion of a communication session over the connection between the primary network device and the called device, terminating contact between the primary network device and the called device, and the primary network device notifying the secondary network devices that the primary network device is currently idle.

In an embodiment of the third aspect, the call processing feature is placing a call on hold, wherein a first secondary network device and an other device are currently engaged in a communication session, the method comprising the first secondary network device placing a call with the other device on hold, the first secondary network device handing over control of the call on hold to the primary network device, the primary network device terminating contact with the first secondary network device, and the first secondary network device notifying the secondary network devices of the location and status of the call.

In an embodiment of the third aspect, control of the call on hold includes any one of a group consisting of supplying music for the other device on hold and supplying voice messages for the other device on hold.

In an embodiment of the third aspect, the call processing feature is retrieving a call from hold, wherein the call is currently on hold between the primary network device and an other device, the method comprising a first secondary network device initiating retrieving the call on hold from the primary network device, the primary network device arranging a connection between the first secondary network device and the other device via protocol signaling between the primary network device and the other device upon completion of a communication session between a user of the other device and a user of the first secondary network device, terminating contact between the other device and the primary network device and the primary network device terminating contact with the first secondary network device, and after the primary network device terminates contact with the first secondary network device, the first secondary network device notifying all network devices that the first secondary network device has completed its involvement with the retrieving the call from hold call processing feature and contact between the first secondary network device and other devices has been terminated and the first secondary network device is currently idle.

In an embodiment of the third aspect, the primary network device network device terminates contact with a network device that originally placed the call on hold, and following the first secondary network device being connected to the other device, the first secondary network device informs the primary network device and secondary network devices that the first secondary network device has successfully picked up the hold.

In an embodiment of the third aspect, the call processing feature is a blind transfer to a peer-to-peer packet-based network device within a peer-to-peer system comprising at least the BCA Group, wherein a first secondary network device and an other device are currently engaged in a communication session, the method comprising the first secondary network device initiating transferring of a call from the other device to a transfer receiving network device, the first secondary network device placing the call on hold and handing over control of the call on hold to the primary network device, the first secondary network device contacting the primary network device to have the primary network device contact the transfer receiving network device, the primary network device contacting the transfer receiving network device and inviting the transfer receiving network device to accept the call from the other device currently on hold, the transfer receiving network device accepting the call, the primary network device arranging a connection between the other device and the transfer receiving network device via protocol signaling, upon connection of the other device and the transfer receiving network device, the primary network device terminating contact with the first secondary network device, after the primary network device terminates contact with the first secondary network device, the first secondary network device notifying all network devices that the first secondary network device has completed its involvement with the blind transfer call processing feature and contact between the first secondary network device and other devices has been terminated and the first secondary network device is currently idle.

In an embodiment of the third aspect, the call processing feature is an attended transfer to peer-to-peer packet-based network device within a peer-to-peer system comprising at least the BCA Group, wherein a first secondary network device and an other device are currently engaged in a communication session, the method comprising the first secondary network device initiating transferring of a call from the other device to a transfer receiving network device, the first secondary network device placing the call on hold and handing over control of the call on hold to the primary network device, the first secondary network device contacting the transfer receiving network device and the user of the first secondary network device introducing the call to the user of the transfer receiving network device, the first secondary network device placing the call with the transfer receiving network device on hold, the first secondary network device contacting the primary network device, passing control of the call with the transfer receiving network device currently on hold and having the primary network device arrange connecting the calls currently on hold, the primary network device contacting the transfer receiving network device and inviting the transfer receiving network device to accept the call from the other device currently on hold, the transfer receiving network device accepting the call, the primary network device arranging a connection between the caller device and the transfer receiving network device via protocol signaling, upon connection of the caller device and the transfer receiving network device, the primary network device terminating contact with the first secondary network device, and after the primary network device terminates contact with the first secondary network device, the first secondary network device notifying all network devices that the first secondary network device has completed its involvement with the attended transfer call processing feature and contact between the first secondary network device and other devices has been terminated and the first secondary network device is currently idle.

In an embodiment of the third aspect, the primary network device and the secondary network devices are VoIP terminal sets.

In an embodiment of the third aspect, the primary network device is assigned at least one backup primary network device and when the primary network device is not connected within the BCA Group, the at least one backup primary network device performs tasks of the primary network device that would have been performed by the primary network device if the primary network device was connected within the BCA Group.

In an embodiment of the third aspect, when the calling device cannot contact the primary network device, a backup primary network device that is known to be assigned to the primary network device is contacted to perform tasks that would have otherwise been performed by the primary network device if the primary network was available for contact by the calling device.

According to a fourth broad aspect of the present invention, there is provided a communication system comprising; a peer-to-peer network comprising; at least one BCA Group according to the first aspect, wherein a network device is designated as a primary network device and remaining network devices are designated as secondary network devices, the secondary network devices adapted to provide support for the primary network device when the primary network device is unavailable; and at least one access interface coupled to the at least one BCA Group, the at least one access interface providing access to communication networks external to the peer-to peer system; and at least one communication network external to the peer-to-peer network coupled to the peer-to-peer network via the at least one access interface; wherein the primary network device of the BCA Group acts as an intermediary for communication involving a secondary network device in the BCA Group and an other device with which the secondary network device in the BCA Group is communicating, wherein protocol signaling for establishing a network device-to-device connection between the other device and the secondary network device in the BCA Group is transmitted via the primary network device.

In an embodiment of the fourth aspect, the primary network device is assigned at least one backup primary network device and when the primary network device is not connected within the BCA Group, the at least one backup primary network device performs tasks of the primary network device that would have been performed by the primary network device if the primary network device was connected within the BCA Group.

According to a fifth broad aspect of the present invention, there is provided a VoIP terminal set for use in the BCA Group according to the first aspect.

According to a sixth broad aspect of the present invention, there is provided a computer usable medium for use in a network device having computer readable program code means embodied therein, the computer readable program code means for implementing BCA call processing features in a distributed manner for a BCA Group comprising a plurality of interconnected peer-to-peer packet-based network devices each equipped with the computer readable program code means.

In an embodiment of the sixth aspect, the computer useable medium further comprises computer readable program code means for assigning at least one backup primary network device to a primary network device and when the primary network device is not connected within the BCA Group, the at least one backup primary network device performing tasks of the primary network device that would have been performed by the primary network device if the primary network device was connected within the BCA Group.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Preferred embodiments of the invention will now be described with reference to the attached drawings in which:

FIG. 1 is a block diagram of a Bridge Call Appearance (BCA) Group provided by an embodiment of the invention;

FIG. 2 is a block diagram of a distributed peer-to-peer network including at least one BCA group as illustrated in FIG. 1.

FIG. 3 is a signal flow chart illustrating signal flow for a BCA call processing feature of receiving an incoming call as provided by an embodiment of the invention;

FIG. 4 is a signal flow chart illustrating signal flow for a BCA call processing feature of placing an outgoing call as provided by an embodiment of the invention;

FIG. 5 is a signal flow chart illustrating signal flow for a BCA call processing feature of placing a call on hold as provided by an embodiment of the invention;

FIG. 6 is a signal flow chart illustrating signal flow for a BCA call processing feature of retrieving a call from hold as provided by an embodiment of the invention;

FIG. 7A is a signal flow chart illustrating signal flow for a BCA call processing feature of a blind transfer from one terminal to another terminal as provided by an embodiment of the invention;

FIG. 7B is a signal flow chart illustrating signal flow for a second embodiment of a BCA call processing feature of a blind transfer from one terminal to another terminal;

FIG. 8 is a signal flow chart illustrating signal flow for a BCA call processing feature of an attended transfer from one terminal to another terminal;

FIG. 9 is a signal flow chart illustrating signal flow for a second embodiment of a BCA call processing feature of an attended transfer from one terminal to another terminal;

FIG. 10 is a functional block diagram of software operating on a terminal set of FIG. 1 or FIG. 2;

FIG. 11 is a flow chart for a method of initiating a call from one network device to another network device which employs backup network devices if the desired network device is not available; and

FIG. 12 is a signal flow chart illustrating signal flow for a BCA call processing feature of receiving an incoming call when a primary terminal is not available and a backup primary terminal is used instead, as provided by an embodiment of the invention.

### DETAILED DESCRIPTION OF THE PREFERRED EMBODIMENTS

Embodiments of the invention provide a distributed peer-to-peer network Bridge Call Appearance (BCA) functionality for performing call processing features which are implemented locally on network devices.

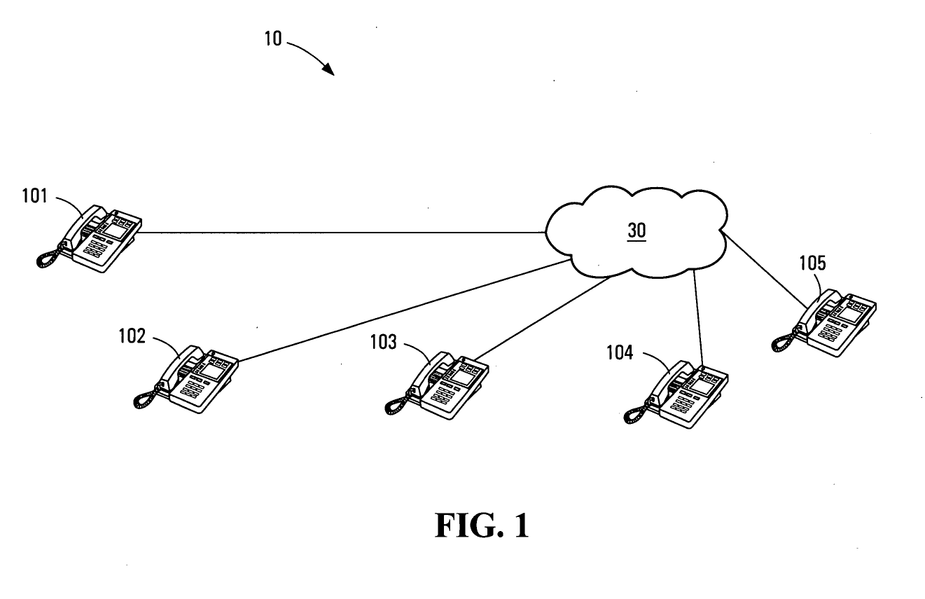

Referring to FIG. 1, shown is an example implementation of a BCA Group generally indicated by 10 which makes use of distributed peer-to-peer call processing provided by an embodiment of the invention.

A BCA Group is considered to be a group of peer-to-peer packet-based network devices in which one or more of the network devices is designated to be an intermediary for protocol signaling of calls occurring within the BCA Group. For example, calls originating outside the BCA Group which are directed to a network device within the BCA Group have protocol signaling for establishing the call, maintaining the call, and disconnecting the call handled via the intermediary network device. In a similar fashion calls originating within the BCA Group which are directed to a network device outside the BCA Group have protocol signaling for establishing the call, maintaining the call, and disconnecting the call handled via the intermediary network device as well. Calls originating within the BCA Group for a network device within the BCA Group also require similar protocol signaling for establishing the call. A practical example of a use for such a BCA Group that would support BCA call processing features provided by embodiments of this invention is an office environment having a boss with several administrative assistants. The boss has a terminal set and the administrative assistants each have terminal sets. This group of terminal sets would be considered a BCA Group wherein the boss's terminal set is designated as a primary terminal set, to act as the intermediary as described above, and the terminal sets of the administrative assistants provide support for the boss's terminal set. When a call comes in for the primary terminal set all phones in the BCA ring simultaneously. If so desired, one of the administrative assistant terminal sets can accept responsibility for the call and the administrative assistant will then handle the call accordingly by conversing with the caller, placing the call on hold, transferring the call, or initiating other call processing features. Protocol signaling steps taken to deal with the call by the administrative assistant terminal set are handled via the boss's terminal set, as will be described in more detail below.

BCA Group 10 shows five network devices in the form of terminal sets 101,102,103,104,105 coupled to a network 30. The network 30 may be for example a LAN (Local Area Network). In the example of FIG. 1 there are five terminal sets 101,102,103,104,105; however, more generally there are a total of N terminal sets where N≧2. In BCA Group 10 one or more terminal sets is designated as a primary terminal. A designation as a primary terminal identifies that a terminal set acts as an intermediary for signaling protocol in establishing, maintaining and disconnecting calls conducted between a terminal set in BCA Group 10 and another terminal set in BCA Group 10 or a terminal set external to BCA Group 10, either internal or external a local peer-to-peer network. Remaining terminal sets in BCA Group 10 are designated as secondary terminals. A designation as a secondary terminal identifies that a terminal set provides support to the primary terminal when the primary terminal is busy or otherwise unavailable. However, the secondary terminals also act independently having many of the same call processing features as the primary terminal.

In some embodiments, where more than one terminal set is designated as a primary terminal within a BCA group, a primary terminal may be designated as a secondary terminal for other primary terminals.

The terminal sets in the BCA Group do not physically need to be in close proximity. However, in some embodiments, it may be advantageous from a user's point of view that the terminal sets in the BCA Group are in close proximity. For example, in the office environment described above the administrative assistants are typically close to the boss and are often aware of the boss's activities. This familiarity allows the administrative assistants to provide knowledgeable support for the boss while using the administrative assistant terminal set.

Embodiments of the invention provide that the terminal sets in the BCA group maintain a listing of connectivity of the BCA terminal sets. For example, the primary terminal maintains a listing of the secondary terminals that are registered to the primary terminal. The primary terminal may also maintain a listing of other primary terminals for which it is acting as a secondary terminal. Each secondary terminal may maintain a listing of which primary terminals it is registered with and which other secondary terminals are registered with those primary terminals.

A terminal set has a user interface used to facilitate normal operation of the terminal set. The terminal set may include some or all of the following: keypads for dialing a number, keypads capable of being assigned to particular call features such as call forwarding, voice mail, transferring a call, etc, and a display for providing text or graphics information to a user of the terminal.

The user interface provides a user of the terminal set to display status of another terminal set. In particular, the user interface displays information regarding status of the designated primary terminal to a user of a designated secondary terminal that is supplied by messages sent from the primary terminal. For example, in some embodiments the user interface includes illuminated keypads. An illuminated keypad is used to answer a call and a manner of the keypad being illuminated indicates the status of the call. In some embodiments, the user interface includes a liquid crystal display (LCD) for displaying graphics or text information regarding the status of the call such as words indicating if a call is active, ringing, on hold, or being transferred as well as numbers indicating directory numbers or extensions related to the status of the call.

In some embodiments provided by the invention the BCA Group is set up by an administrator. For example, the administrator establishes a BCA Group by selecting a particular terminal set to be the primary terminal and selects other terminal sets to act as secondary terminals for the BCA Group. The information identifying the primary and secondary terminals included in the established BCA Group is then propagated to other terminal sets in the overall network using peer-to-peer information propagation techniques. In some embodiments the information is only propagated to those terminal sets that need the information, such as the primary and secondary terminals of the established BCA Group. In some embodiments, the information is propagated using techniques described in co-pending U.S. Patent Application entitled “INFORMATION DISTRIBUTION SYSTEM, METHOD AND NETWORK DEVICE, filed Sep. 30, 2004 <attorney docket number 50447-21>.

In some embodiments, the administrator uses the terminal set user interface to designate which terminals are primary terminals and which terminals are secondary terminals. In some embodiments, the administrator uses a web tool for accessing the terminals via the network 30 to designate which terminals are primary terminals and which terminals are secondary terminals.

Preferably, network devices used in the BCA Group are packet-based telephones such as IP (Internet Protocol) telephone terminal sets. Other examples are a video phone, a PDA (Personal Digital Assistants), a wireless device, a computer supporting peer-to-peer voice over packet-based communication or a wireless telephone that can be suitably programmed and configured to provide the BCA call processing features described below. In some cases, the terminal sets are for example IP phones such as that manufactured by Mitel, Nortel, Avaya, Siemens, NEC, Pingtel or 3COM.

BCA Group 10 comprises a plurality of interconnected peer-to-peer network devices 101,102,103,104,105 for collectively implementing BCA call processing features in a distributed manner.

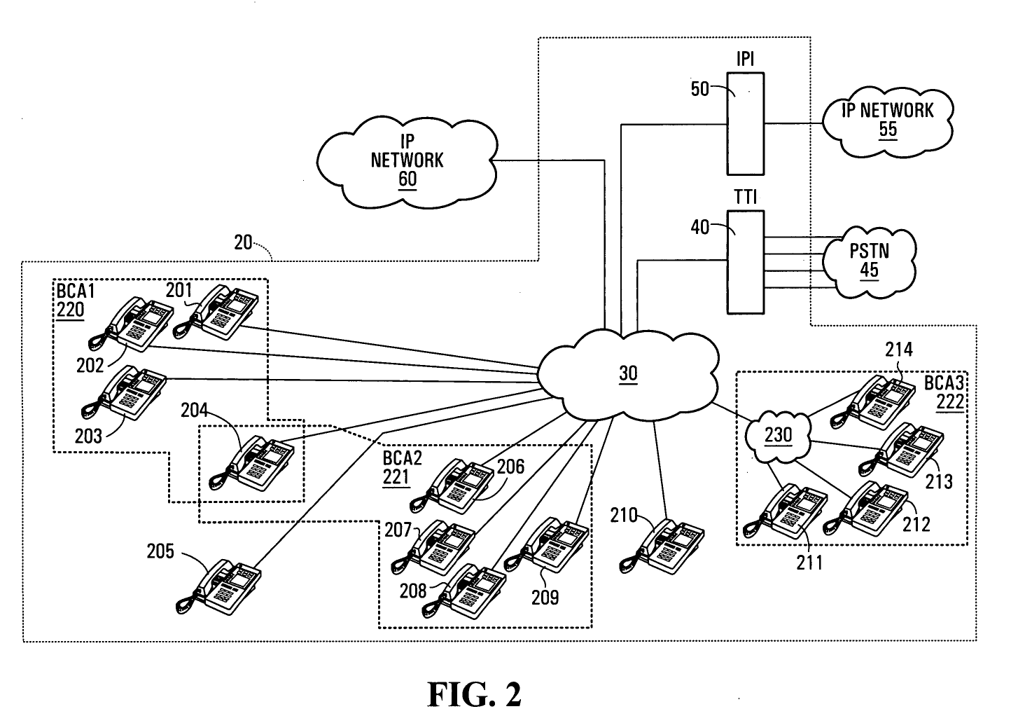

Referring now to FIG. 2, a peer-to-peer network 20 including at least one BCA Group 10 as described in FIG. 1 will now be described.

The peer-to-peer network 20 is shown to have three BCA Groups. A first BCA Group BCA1 220 is shown to include terminal sets 201,202,203,204, a second BCA Group BCA2 221 is shown to include terminal sets 204,206,207,208,209, and a third BCA Group BCA3 222 is shown to include terminal sets 211,212,213. In BCA1 220, terminal set 201 is designated as a primary terminal and terminal sets 202,203,204 are designated as secondary terminals. In BCA2 221, terminal set 206 is designated as a primary terminal and terminal sets 204,207,208,209 are designated as secondary terminals. In BCA3 222, terminal set 211 is designated as a primary terminal and terminal sets 212,213 are designated as secondary terminals. The peer-to-peer network 20 also is shown to include two individual terminal sets 205,210. In some embodiments, the network 30 is the same network that all the terminal sets in the peer-to-peer network 20 are coupled to, i.e. the terminal sets in the respective BCA Groups BCA1 220 and BCA2 221 are coupled to network 30. In some embodiments the terminal sets of the BCA Group, such as terminal sets 211,212,213 of BCA3 222 may be coupled to a local network 230 and that local network is coupled to network 30. In the example of FIG. 2 there are only three BCA Groups BCA1 220, BCA2 221, BCA3 222 and two terminal sets 205, 210. However, more generally in a peer-to-peer network there are a total of N BCA Groups containing M terminal sets where N≧1 and M≧2 as well as any number of individual terminal sets not assigned to any BCA Group. Furthermore, BCA Groups may not necessarily be distinct. A member of one BCA Group may also be a member of another BCA Group as shown by terminal set 204 which is in both BCA1 220 and BCA2 221.

Connected to the network 30 as shown in FIG. 2 is a Thin Trunk Interface (TTI) 40. The TTI 40 is, for example, a basic Analog or digital T1/E1 interface or any other suitable PSTN interface and provides a local central office or PSTN (Public Switched Telephone Network) interface. The TTI 40 is coupled to a number of telephone “lines”. The lines are wire pairs coupled to PSTN 45. In some implementations, there are many lines requiring multiple thin trunk interfaces. For example, in one implementation, if 8 lines are required for connection to the PSTN 45 and each TTI 40 has four lines then a second TTI 40 is added to the peer-to-peer network 20.

In some embodiments the peer-to-peer network 20 has a plurality of connections to an Internet Protocol (IP) network 60, possibly having as many connections as there are terminal sets coupled to the peer-to-peer network 20. In some embodiments, the IP network 60 includes a centralized server (not shown) which is used to route calls between nodes coupled to the IP network 60 and terminal sets coupled to the peer-to-peer network 20. In some embodiments the IP network 60 is a conventional network in which packetized data is transferred between network nodes. In some embodiments the IP network 60 is a Voice over IP (VoIP) network.

In some embodiments, an interface coupled to the network 30 is an Internet Protocol Interface (IPI) 50. The IPI 50 is coupled to IP Network 55. The IPI 50 acts as a device to limit the number of connections to the network 30. As opposed to having a permanent packetized protocol connection for every extension or terminal set of the peer-to-peer network 20, the IPI 50 functions to make a temporary connection between a terminal set external to the peer-to-peer network 20 (coupled to the peer-to-peer network 20 through IP network 55) and a terminal set within the peer-to-peer network 20.

In some embodiments the peer-to-peer network 20 has only IPI 50 and no TTI 40. In other embodiments the peer-to-peer network 20 has both IPI 50 and TTI 40. In some embodiments multiple IPIs 50 may be used. In some embodiments IP network 55 and IP network 60 are the same IP network.

Embodiments of the invention provide that the TTI 40 and/or the IPI 50 maintain a listing of connectivity of terminal sets in the peer-to-peer network 20. For example, in some embodiments, the interfaces 40,50 maintain listings of the primary and secondary terminals included in respective BCA Groups. The interfaces 40,50 may also maintain listings of primary terminals that act as a secondary terminals for other primary terminals. The information identifying the primary and secondary terminals included in BCA Groups is propagated to the interfaces 40,50 in the peer-to-peer network 20 using peer-to-peer information propagation techniques in the same manner as information is propagated between peer-to-peer terminals.

It is to be understood that the peer-to-peer network 20 of FIG. 2 is only a specific example of the incorporated subject matter. For example, in some implementations the network 30 forms part of a larger network that is a collection of smaller networks interconnected by way of VPN (Virtual Private Network) connections. Also, in some embodiments provided by the invention not all of the features in FIG. 2 are included, for example the IPI 50 is not necessary in all embodiments.

In the following descriptions of BCA call processing features a device being called by a BCA terminal set or a device calling a BCA terminal set is referred to as “Terminal Device X”. In the following signaling call flows describing embodiments of the invention “Terminal Device X” is a terminal set exterior to the peer-to-peer network 20, TTI 40 or IPI 50 that is routing a call from exterior to the peer-to-peer network 20, a terminal set within the peer-to-peer network 20, or a terminal set within the same BCA group.

A first BCA Group call processing feature provided by embodiments of the invention is receiving an incoming call. In a general case of receiving an incoming call a user of Terminal Device X is calling a user of a primary terminal of the BCA Group. The primary and all secondary terminals will ring simultaneously. If the user of the primary terminal is unavailable to take the call, one of the secondary terminals can accept the call. For example, a first secondary terminal accepts the invitation from the primary terminal and the primary terminal then cancels any outstanding invitations to other secondary terminals in the BCA Group. The primary terminal serves as a signaling bridge to connect Terminal Device X with the first secondary terminal. The first secondary terminal notifies the other secondary terminals that it is connected with Terminal Device X. After a dialog between the users of Terminal Device X and a user of the secondary terminal has been completed the primary terminal arranges the disconnection of the secondary terminal and Terminal Device X.

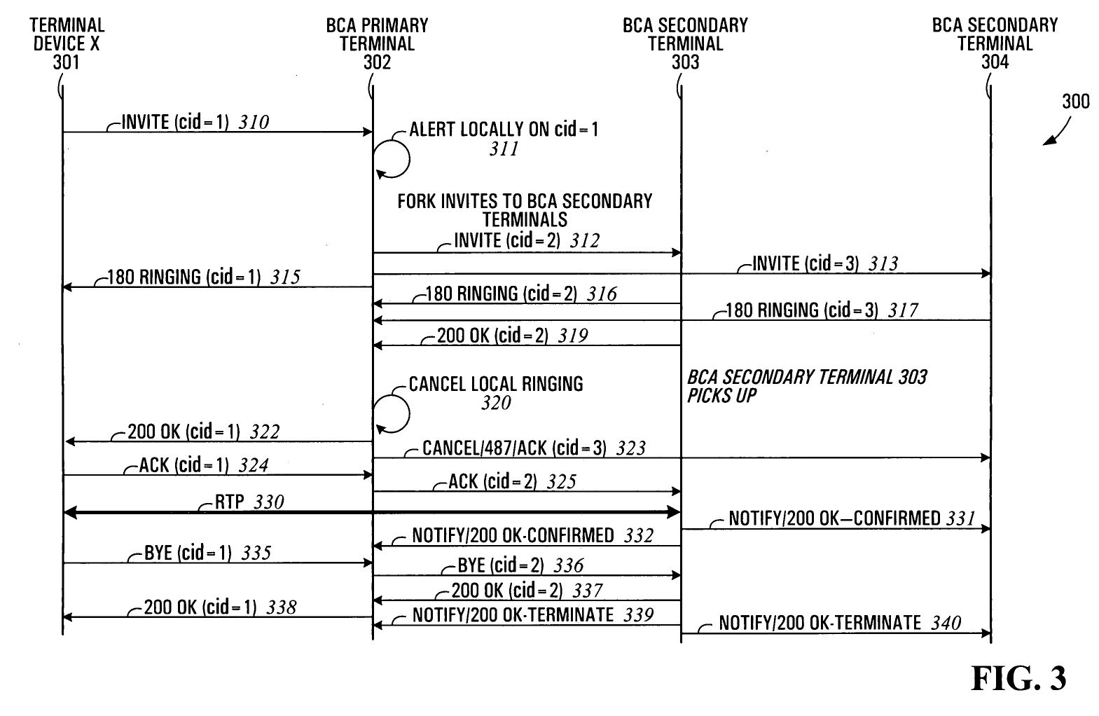

Referring to FIG. 3, an example of a signaling flow 300 for an incoming call to a terminal in a BCA Group will now be described. The particular signaling flow diagram 300 includes signal flow information pertaining to four terminals. A first terminal is Terminal Device X 301, which is placing a call to the primary terminal 302 in the BCA Group. The three terminals in the BCA Group are BCA primary terminal 302, a first BCA secondary terminal 303 and a second BCA secondary terminal 304.

The following signal flow example uses Session Initiation Protocol (SIP) messaging. SIP is a request/response type of protocol. A first device sends a request to a second device. The second device responds to the request and further action results depending in the response of the second device. The SIP core standard (currently RFC 3261), which is incorporated herein by reference defines SIP requests and responses such as INVITE, BYE, OK, and ACK and the manner in which they are used.

As shown in FIG. 3, a first step involves Terminal Device X 301 issuing an “INVITE (cid=1)” request 310 to BCA primary terminal 302. BCA primary terminal 302 issues a local alert 311 within the BCA primary terminal 302 in response to “INVITE (cid=1)” 310. BCA primary terminal 302 knows about (is provisioned with the identification of) all the other BCA terminals in the group as described above based on the establishment of the BCA Group by the administrator. In addition to alerting the BCA primary terminal 302 locally, the BCA primary terminal 302 also simultaneously issues invitations to BCA secondary terminals 303,304 in the form “INVITE (cid=2)” 312 to BCA secondary terminal 303 and “INVITE (cid=3)” 313 to BCA secondary terminal 304 to alert BCA secondary terminals 303,304 of an incoming call to the BCA Group. BCA primary terminal 302 sends a “180 Ringing (cid=1)” 315 signal to Terminal Device X 301. BCA secondary terminal 303 sends a “180 Ringing (cid=2)” 316 signal response to BCA primary terminal 302 and BCA secondary terminal 304 sends a “180 Ringing (cid=3)” 317 response to BCA primary terminal 302. In this example we assume that BCA secondary terminal 303 picks up the call and sends a “200 OK (cid=2)” response 319 to BCA primary terminal 302, for example if the user of BCA primary terminal 302 is away from the terminal at the time of the call. In response, BCA primary terminal 302 cancels local ringing 320 that is occurring on BCA primary terminal 302. BCA primary terminal 302 also sends a “200 OK (cid=1)” message 322 to Terminal Device X 301 to announce the call will be received by a terminal in the BCA Group. BCA primary terminal 302 sends out “CANCEL/487/ACK (cid=3)” 323 to BCA secondary terminal 304 to cancel the original “Invite” request 310. Terminal Device X 301 sends an acknowledgement 324 in the form “ACK (cid=l)” to BCA primary terminal 302 and BCA primary terminal 302 sends an acknowledgement 325 in the form “ACK (cid=2)” to BCA secondary terminal 303. At this point in time a connection is established between Terminal Device X 301 and the BCA secondary terminal 303, wherein information is transmitted 330 between the two terminals 301,303 using Real-time Transfer Protocol (RTP). BCA secondary terminal 303 sends a “NOTIFY/200 OK-Confirmed” message 331 and “NOTIFY/200 OK-Confirmed” message 332 to BCA secondary terminals 302 and 304 respectively to notify BCA terminals 302 and 304 that BCA secondary terminal 303 is occupied with the call from Terminal Device X 301. Upon completion of a dialog between a user of Terminal Device X 301 and a user of BCA secondary terminal 303, Terminal Device X 301 sends a “BYE (cid=1)” message 335 to BCA primary terminal 302 and BCA primary terminal 302 sends a “BYE (cid=2)” message 336 to BCA secondary terminal 303. BCA secondary terminal 303 responds with “200 OK (cid=2)” 337 to BCA primary terminal 302 and BCA primary terminal 302 sends “200 OK (cid=1)” 338 to Terminal Device X 301. After message 338, BCA secondary terminal 303 sends a signal “NOTIFY/200 OK-Terminate” 339,340 to both BCA terminals 302 and 304 to notify the BCA terminals 302,304 that the BCA secondary terminal 303 is finished with its part in the call processing feature 300.

FIG. 3 is one example of how an incoming call could be handled by the BCA Group. In the example, BCA secondary terminal 303 accepts the invitation and picks up the call. In other situations BCA secondary terminal 304 picks up the call resulting in a similar flow but different call identifiers (cid) in the signaling protocol between terminals. In a situation where more than two BCA secondary terminals are involved, the call is picked up by any available secondary terminal.

A second BCA Group call processing feature provided by embodiments of the invention is placing an outgoing call. In a general case of placing an outgoing call, a user of a BCA Group primary terminal is calling a user of Terminal Device X. The primary terminal sends a notification to all secondary terminals registered with the primary terminal that the primary terminal is trying to contact Terminal Device X. After a connection between Terminal Device X and the primary terminal is established the primary terminal sends confirmation to all the secondary terminals that connection has been made with Terminal Device X and the primary terminal is now busy. After a dialog between Terminal Device X and the primary terminal has been completed the primary terminal notifies all the secondary terminals that the primary terminal has completed the call with Terminal Device X and that the primary terminal is available.

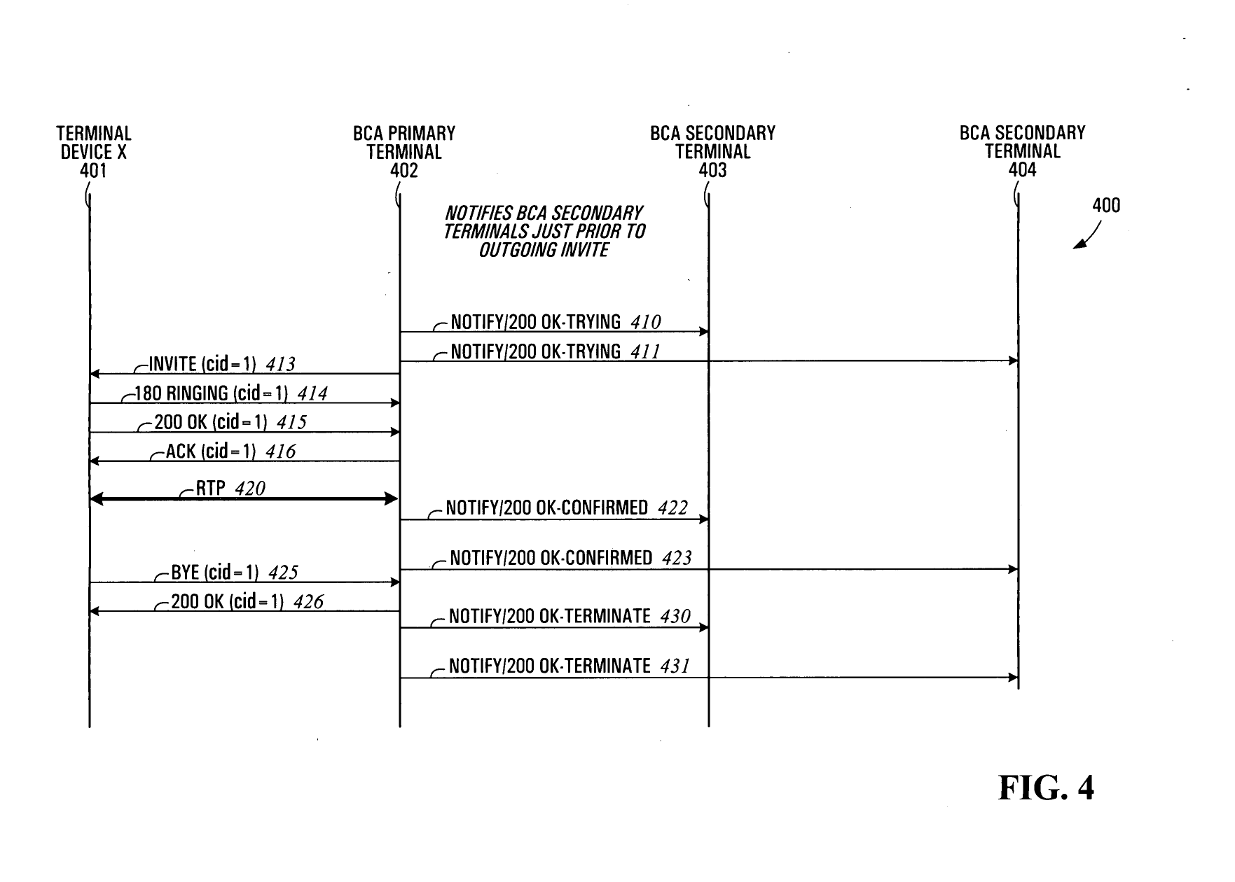

Referring to FIG. 4, an example of a signaling flow 400 for an outgoing call from a terminal in the BCA Group will now be described. The particular signaling flow diagram 400 includes signal flow information pertaining to four terminals, Terminal Device X 401, BCA primary terminal 402, first BCA secondary terminal 403 and second BCA secondary terminal 404.

As shown in FIG. 4, a first step involves the BCA primary terminal 402 sending a “NOTIFY/200 OK-Trying” message 410, 411 to BCA secondary terminal 403 and BCA secondary terminal 404 before sending an “INVITE” to Terminal Device X 401. BCA primary terminal 402 then issues an “INVITE (cid=1)” 413 request to Terminal Device Xoutside terminal 401. Terminal Device X 401 sends a “180 Ringing (cid=1)” 414 signal response to BCA primary terminal 402. Terminal Device X 401 further sends a “200 OK (cid=1)” 415 message to BCA primary terminal 402. In response to the “200 OK (cid=1)” 415 sent by Terminal Device X 401, BCA primary terminal 402 sends an acknowledgement 416 in the form “ACK (cid=1)”. At this point in time a connection is established between BCA primary terminal 402 and Terminal Device X 401, wherein information is transmitted 420 between the two terminals 401,402 using RTP. BCA primary terminal 402 sends a “NOTIFY/200 OK-Confirmed” message 422 to BCA secondary terminal 403 and a “NOTIFY/200 OK-Confirmed” message 423 to BCA secondary terminal 404 to notify those terminals that BCA primary terminal 402 is occupied with a call to Terminal Device X 401. Upon completion of a dialog between a user of Terminal Device X 401 and a user of BCA primary terminal 402, Terminal Device X 401 sends a “BYE (cid=1)” message 425 to BCA primary terminal 402 and BCA primary terminal 402 sends a “200 OK (cid=1)” message 426 to Terminal Device X 401. BCA primary terminal 402 sends a “NOTIFY/200 OK-Terminate” message 430 to BCA secondary terminal 403 and a “NOTIFY/200 OK-Terminate message” 431 to BCA secondary terminal 404 to notify those terminals that BCA primary terminal 402 has completed the call with Terminal Device X 401.

A third BCA Group call processing feature provided by embodiments of the invention is placing a call on hold. In a general case of placing a call on hold a user of a BCA Group terminal places a call on hold from another terminal, internal or external to the peer-to-peer network. For example, it is assumed that a user of a first secondary terminal is connected to Terminal Device X and wishes to place the user of Terminal Device X on hold. In initiating placing the call on hold the first secondary terminal sends an invitation to the primary terminal it is registered with to accept control of the call on hold. The primary terminal sends an invitation to Terminal Device X to be placed on hold. After Terminal Device X accepts being placed on hold the primary terminal takes over control of the hold and establishes a one way connection with Terminal Device X.

Some embodiments of the hold call processing function are done this way to relieve a secondary terminal from streaming media, for example music-on-hold, while the call is placed on hold. The primary terminal will assume this responsibility. In a case where the secondary terminal has to monitor several primary terminals, this may help to reduce the load on the secondary terminal, hence improving the overall network scalability.

The one way RTP connection between the primary terminal and Terminal Device X allows the primary terminal to supply media such as music or voice messages to Terminal Device X while it is on hold. While the primary terminal plays music-on-hold to Terminal Device X, there is no media flowing between the primary terminal and the first secondary terminal. The first secondary terminal also notifies the rest of the BCA group that the call is being held at primary terminal.

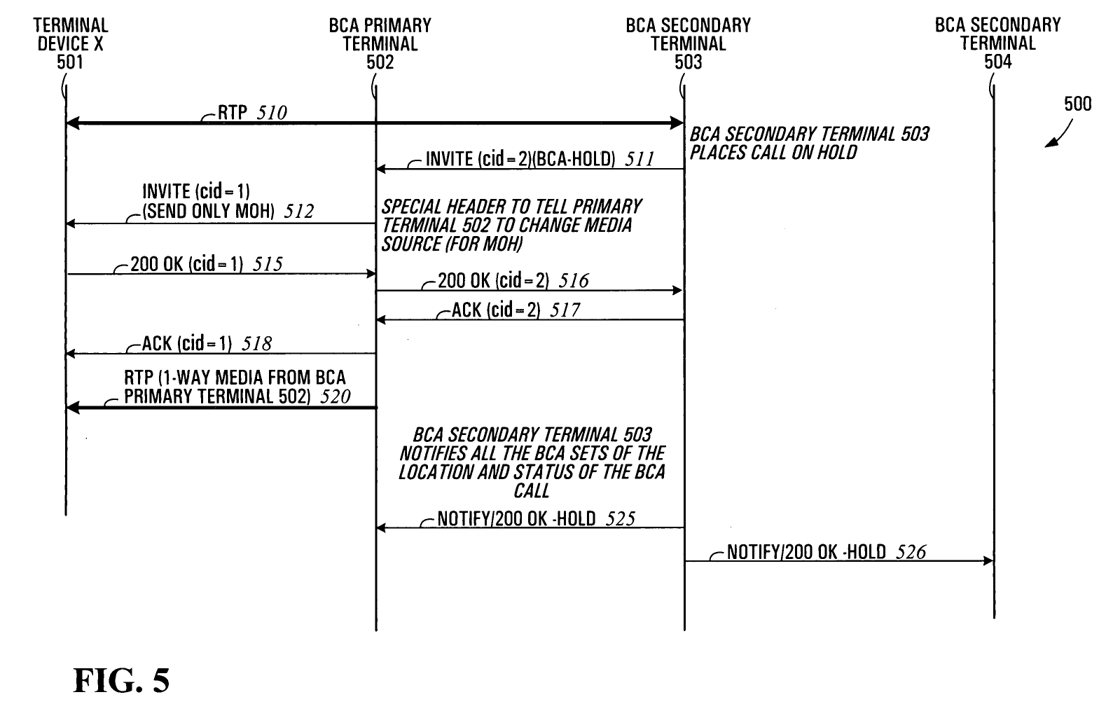

Referring to FIG. 5, an example of a signaling flow 500 for a terminal in the BCA Group placing a call on hold will now be described. The particular signaling flow diagram 500 includes signal flow information pertaining to four terminals, Terminal Device X 501, BCA primary terminal 502, first BCA secondary terminal 503 and second BCA secondary terminal 504.

As shown in FIG. 5, a connection is currently established between Terminal Device X 501 and BCA secondary terminal 503, wherein information is transmitted 510 between the two terminals 501, 503 using RTP. A first step of the process involves BCA secondary terminal 503 initiating placing the call on hold. BCA secondary terminal 503 sends an “INVITE (cid=2)(BCA-hold)” request 511 that includes a special header to tell BCA primary terminal 502 to change media source, for example, supplying music-on-hold or some other signal that indicates to a caller on hold that the call is still active. Alternatively, the special header (BCA-hold) can be excluded in request 511. In this case, BCA primary terminal 502 determines that the request 511 is for a “bca hold” when the request 511 contains one of the following in a Session Description Protocol (SDP): connection IP address c=0.0.0.0, or an attribute field set to send-only (a=send-only) or to inactive (a=inactive). After determining that the request 511 is for a “bca hold”, BCA primary terminal 502 can play the appropriate hold media, such as “music on hold” (MOH), toward Terminal Device X. BCA primary terminal 502 sends an “INVITE (cid=l)(send-only MOH)” request 512 to Terminal Device X 501. Terminal Device X 501 responds with “200 OK (cid=1)” 515 and then BCA primary terminal 502 further sends a “200 OK (cid=2)” response 516 to BCA secondary terminal 503. BCA secondary terminal 503 responds to “200 OK (cid=2)” 516 from BCA primary terminal 502 with an acknowledgement in the form “ACK (cid=2)” 517. BCA primary terminal 502 sends an “ACK (cid=1)” 518 to Terminal Device X 501. At this point a connection is made between Terminal Device X 501 and BCA primary terminal 502. The connection is a one way connection for transmitting 520 media such as music or voice messages using RTP from BCA primary terminal 502 to Terminal Device X 501 while Terminal Device X the outside terminal 501 is on hold. BCA terminal 503 then notifies all BCA terminals 502,504 of the location and status of the hold by sending a “NOTIFY/200 OK-HOLD” message 525, 526 to all BCA terminals 502, 504.

In FIG. 5 there are only two BCA secondary terminals to notify about a status of hold, more generally the BCA primary terminal notifies all terminals in the BCA Group of the hold status.

A fourth BCA Group call processing feature is retrieving a call from hold. In a general case of retrieving a call from hold a user of a BCA Group terminal retrieves a call that is placed on hold by a first secondary terminal and currently on hold by the primary terminal. For example, a second secondary terminal sends an invitation to the primary terminal it is registered with to retrieve the call on hold. The primary terminal sends an invitation to Terminal Device X to take the call off-hold and to attempt to connect Terminal Device X with the second secondary terminal which is trying to pick up the call. At the same time, the primary terminal also sends a message to the first secondary terminal that originally put the call on hold to terminate that call, which has been replaced by the call from a second secondary terminal that is trying to pick up the held call. After Terminal Device X accepts the invitation, the primary terminal establishes a connection between Terminal Device X and the second secondary terminal that is picking up the call. After connection between Terminal Device X and the secondary terminal has been established, the second secondary terminal notifies all the secondary terminals and the primary terminal that it has retrieved the call from hold. After a dialog between a user of Terminal Device X and a user of the second secondary terminal has been completed the primary terminal still acting as the intermediary for signaling protocol between Terminal Device X and the second secondary terminal notifies the second secondary terminal that the user of Terminal Device X has terminated the call. The second secondary terminal then notifies all other BCA Group terminals that the call has been terminated and the first secondary terminal is available.

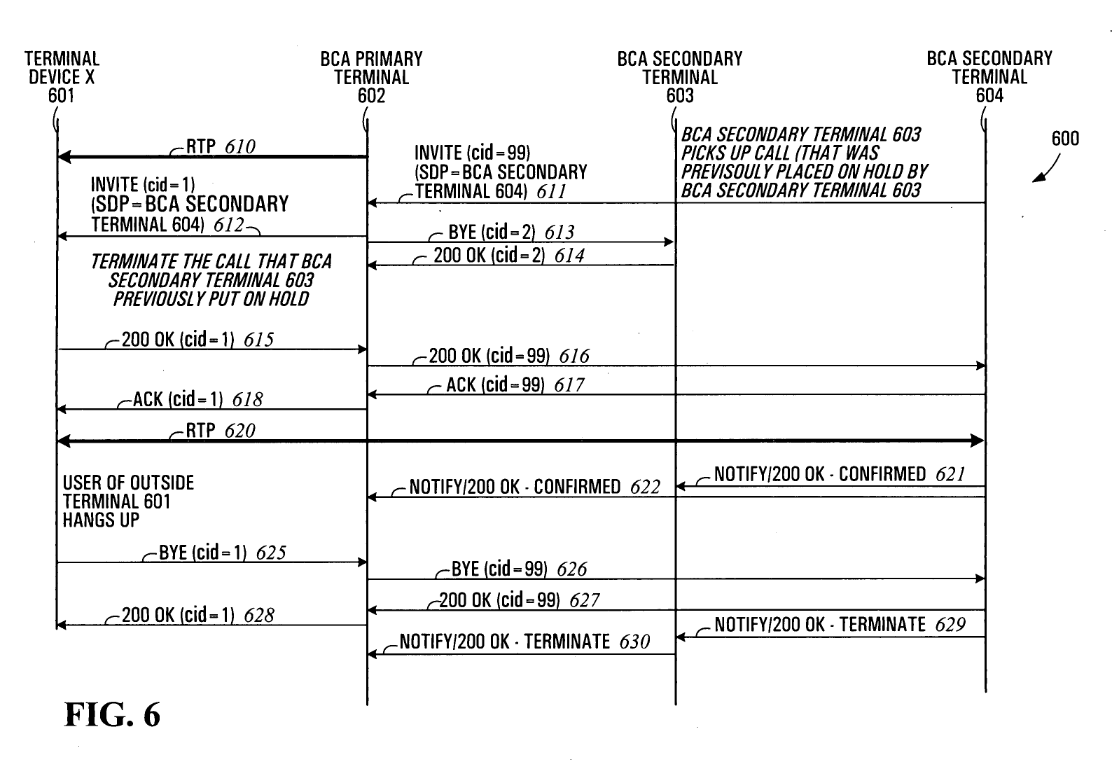

Referring to FIG. 6, an example of a signaling flow 600 for a terminal in the BCA Group retrieving a call from hold will now be described. The particular signaling flow diagram 600 includes signal flow information pertaining to four terminals, Terminal Device X 601, BCA primary terminal 602, first BCA secondary terminal 603 and second BCA secondary terminal 604.

As shown in FIG. 6, a one way RTP connection is currently established between Terminal Device X 601 and BCA primary terminal 602, wherein information is transmitted 610 from BCA primary terminal 602 to Terminal Device X 601. A first step of the process involves BCA secondary terminal 604 initiating retrieving the call which was placed on hold by BCA secondary terminal 603. BCA secondary terminal 604 sends an “INVITE (cid=99)(Replaces:cid 2) (SDP=BCA secondary terminal 604)” request 611 to BCA primary terminal 602. Call cid=99 represents a new call initiated from BCA secondary terminal 604 to replace call cid=2 that is being held at BCA primary terminal 602. BCA primary terminal 602 sends an “INVITE (cid=1)(SDP=BCA secondary terminal 604)” request 612 to Terminal Device X 601. BCA primary terminal 602 realizes that this is a call to replace call cid=2 that was previously put on hold by BCA secondary terminal 603. BCA primary terminal 602 sends a “BYE (cid=2)” signal 613 to BCA secondary terminal 603 to terminate that call and in response BCA secondary terminal 603 sends a “200 OK (cid=2)” message 614 back to BCA primary terminal 602. Terminal Device X 601 responds to the “INVITE” 612 with “200 OK (cid=1)” 615 and then BCA primary terminal 602 further sends a “200 OK (cid=99)” message 616 to BCA secondary terminal 604. BCA secondary terminal 604 responds to “200 OK (cid=99)” 616 from BCA primary terminal 602 with an acknowledgement in the form “ACK (cid=99)” 617. BCA primary terminal 602 sends an “ACK (cid=1)” 618 to Terminal Device X 601. At this point in time a connection is established between Terminal Device X 601 and BCA secondary terminal 604, wherein information is transmitted 620 between the two terminals 601, 604 using RTP. BCA secondary terminal 604 sends a “NOTIFY/200 OK-Confirmed” message 621, 622 to BCA secondary terminal 603 and BCA primary terminal 602, respectively to notify these terminals that BCA secondary terminal 604 is busy with the call involving Terminal Device X 601. Upon completion of a dialog between the user of Terminal Device X 601 and the user of BCA secondary terminal 604, Terminal Device X 601 terminates the call with BCA secondary terminal 604 by sending “BYE (cid=1)” 625 to BCA primary terminal 602. BCA primary terminal 602 sends “BYE (cid=99)” 626 to BCA secondary terminal 604 and in response BCA secondary terminal 604 sends a “200 OK (cid=99)” 627 message back to BCA primary terminal 602. BCA primary terminal 602 sends a “200 OK (cid=1)” message 628 to Terminal Device X 601. BCA secondary terminal 604 sends a “NOTIFY/200 OK-Terminate” signal 629, 630 to BCA terminals 602, 603 notifying the BCA terminals 602, 603 that BCA secondary terminal 604 has terminated connection with Terminal Device X 601.

In another embodiment, in which BCA primary terminal 602 is picking up the held call, BCA primary terminal 602 simply sends a “BYE” message to BCA secondary terminal 603 that put the call on hold originally, to tear down that call (cid=2). It would then re-invite Terminal Device X 601, which essentially would take Terminal Device X 601 off of music-on-hold and resume 2-way media directly with BCA primary terminal 602. After this, BCA primary terminal 602 would notify (“NOTIFY/200 OK-Confirmed”) the secondary BCA terminals 602, 603 that it is taking the call.

Additional BCA Group call processing features include blind and attended transfers from one terminal in the BCA Group to another terminal. In a general case of transferring a call from a user of a BCA Group terminal to another terminal, a first step involves utilizing aspects of the hold call processing feature as described above. For example, a first secondary terminal uses the hold feature to place the call on hold while it performs the steps necessary to complete the transfer. In one embodiment of a blind transfer call processing feature the first secondary terminal sends an invitation to the terminal of a desired destination to accept the call. If the invitation is accepted the first secondary terminal transfers control of the call back to the primary terminal. The primary terminal sends an invitation to the terminal of the desired destination to connect the terminal of the desired destination with the call and upon acceptance of the invitation connects Terminal Device X and the terminal of the desired destination. Upon successfully establishing the connection the primary terminal sends notification of the successful connection to the first secondary terminal and then the first secondary terminal sends notification to the other BCA Group terminals that it has completed its function in the blind transfer and is again available.

In an attended transfer call processing feature the signal flow is similar to a blind transfer call processing feature, however provision is made for the user of the first secondary terminal to introduce the user of the outside terminal.

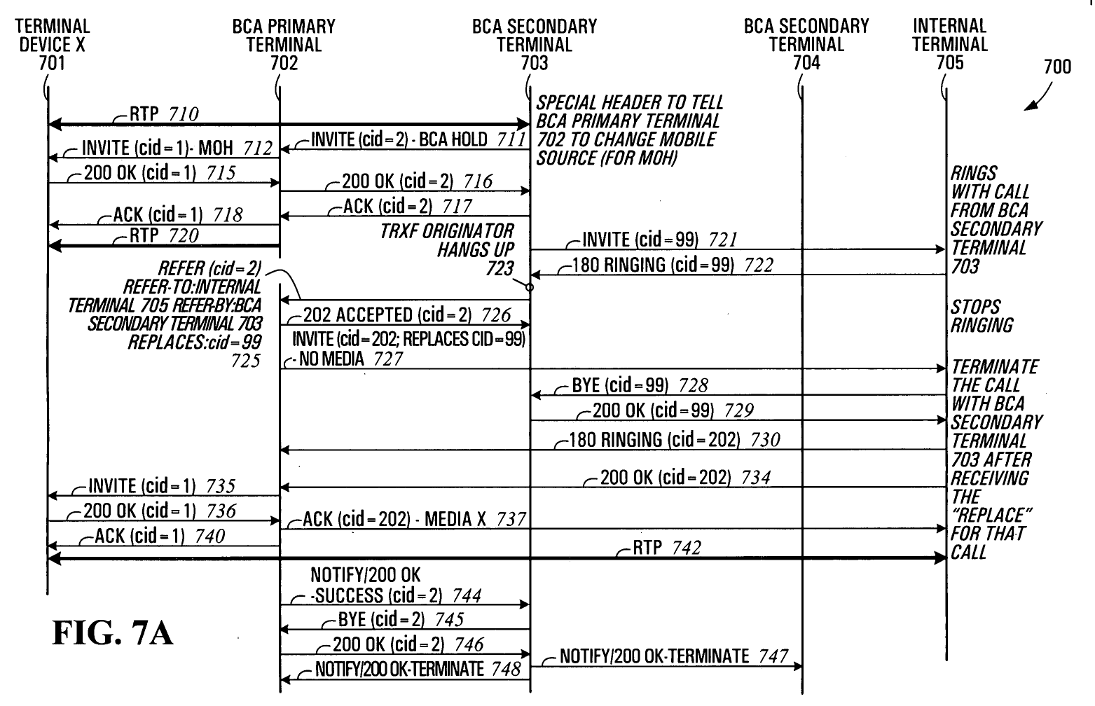

Referring to FIG. 7A, an example of a signaling flow 700 for a blind transfer from one terminal in the BCA Group to another terminal in the peer-to-peer network will now be described. The particular signaling flow diagram 700 includes signal flow information pertaining to four terminals, Terminal Device X 701, BCA primary terminal 702, first BCA secondary terminal 703 and second BCA secondary terminal 704 plus an additional internal terminal 705.

As shown in FIG. 7A, a connection is currently established between Terminal Device X 701 and BCA secondary terminal 703, wherein information is transmitted 710 between the two terminals 701,703 using RTP. A first step of the process involves BCA secondary terminal 703 initiating transferring a call. Steps 711, 712, 715, 716, 717, 718 and 720 are the same as steps 511, 512, 515, 516, 517, 518 and 520 of the hold call processing feature 500 described above. Following BCA secondary terminal 703 sending BCA primary terminal 702 an “ACK (cid=2)” message 717, BCA secondary terminal 703 also sends an “INVITE (cid=99)” request 721 to internal terminal 705 causing internal terminal 705 to ring and notify a user of internal terminal 705 of an incoming call. Internal terminal 705 sends a “180 Ringing (cid=99)” response back to BCA secondary terminal 703. At this point in time the user of BCA secondary terminal 703 hangs up 723. BCA secondary terminal 703 sends a “REFER (cid=2)” message 725 to BCA primary terminal 702 including the information “Refer-to: Internal Terminal 705”, “Refer-by: BCA secondary terminal 703” and “Replaces: cid=99”. In response to “REFER (cid=2)” 725 BCA primary terminal 702 sends a “202 Accepted (cid=2)” response to BCA secondary terminal 703. Then BCA primary terminal 702 sends an “INVITE (cid=202;replaces cid=99)-no media” request 727 to internal terminal 705. The “INVITE (cid=202;replaces cid=99)-no media” request 727 replaces the existing call cid=99 with cid=202, which is now in a ringing state. This “INVITE” request 727 carries no media description of the calling party because at this point, BCA primary terminal 702 is still playing music to Terminal Device X 701. Since call cid=99 is being replaced, internal terminal 705 sends a “BYE (cid=99) 728 signal to BCA secondary terminal 703 to tear down the pending call cid=99. BCA secondary terminal 703 responds to internal terminal 705 with a “200 OK (cid=99) message 729. Internal terminal 705 responds to “INVITE” 727 by sending a “180 Ringing (cid=202)” message 730 to BCA primary terminal 702. Internal terminal 705 also sends a “200 OK (cid=202)” message 734 to the BCA primary terminal 702. The media description of internal terminal 705 is carried in a session description protocol (SDP) within this response. This results in BCA primary terminal 702 sending an “INVITE (cid=1)” request 735 to Terminal Device X 701 with the SDP of terminal 705 learned from the “200 OK” response 734. Terminal Device X 701 responds with a “200 OK (cid=1)” response 736. BCA primary terminal 702 sends an “ACK (cid=202)-media X” 737 to internal terminal 705 followed the receipt of message “200 OK (cid=1)” 736 from Terminal Device X 701. The acknowledgement message 737 to internal terminal 705 carries the media description of Terminal Device X 701 in the associated SDP. BCA primary terminal 702 also sends an “ACK (cid=1)” 740 to Terminal Device X 701 to acknowledge the previous “200 OK (cid=1)” 736 from terminal 701. Hence, at the end of the above-described process in which BCA primary terminal 702 is the signalling intermediary, Terminal Device X 701 and internal terminal 705 have each other's SDP information. A connection is then established between Terminal Device X 701 and internal terminal 705, wherein information is transmitted 742 between the two terminals 701, 705 using RTP. BCA primary terminal 702 further sends a “Notify/200 OK-Success(cid=2)” message 744 to BCA secondary terminal 703 notifying BCA secondary terminal 703 that the transfer has been successfully completed and BCA secondary terminal 703 responds by sending a “BYE (cid=2)” 745 message to BCA primary terminal 702. BCA primary terminal 702 sends “200 OK (cid=2)” 746 to BCA secondary terminal 703 in response to “BYE (cid=2)” 745. The BCA secondary terminal 703 also sends a “Notify/200 OK-Terminate” 747, 748 message to BCA secondary terminal 704 and BCA primary terminal 701 notifying BCA secondary terminal 704 and BCA primary terminal 702 that BCA secondary terminal 703 has completed its involvement in the call transfer feature process 700.

A second embodiment of a blind transfer call processing feature 707 from one terminal in the BCA Group to another terminal in the peer-to-peer network is shown in FIG. 7B. The difference between the embodiments of FIG. 7A and FIG. 7B is that in FIG. 7B BCA secondary terminal 703 does not send a request inviting internal terminal 705 to accept the transfer, receive a “180 Ringing” response or send a “CANCEL/487/ACK” message to internal terminal 705 as in steps 721, 722 and 724 of blind transfer call processing feature 700. In addition, the “REFER” command of step 750 in FIG. 7B contains slightly different instructions. Therefore, BCA secondary terminal 703 does not contact internal terminal 705 with the “INVITE (cid=99)” request 721, but directly sends a “REFER (cid=2)” 750 message to BCA primary terminal 702 including the information “Refer-to: Internal Terminal 705” and “Refer-by: BCA secondary terminal 703”. Also, the “INVITE” step 751 in call processing feature 707 differs from the “INVITE” step 727 in call processing feature 700 in that cid=202 is not replacing cid=99. As a result, steps 728 and 729 of call processing feature 700 are not required in call processing feature 707. The remaining steps of the second embodiment of the blind transfer feature 707 are the same as the first embodiment of FIG. 7A.

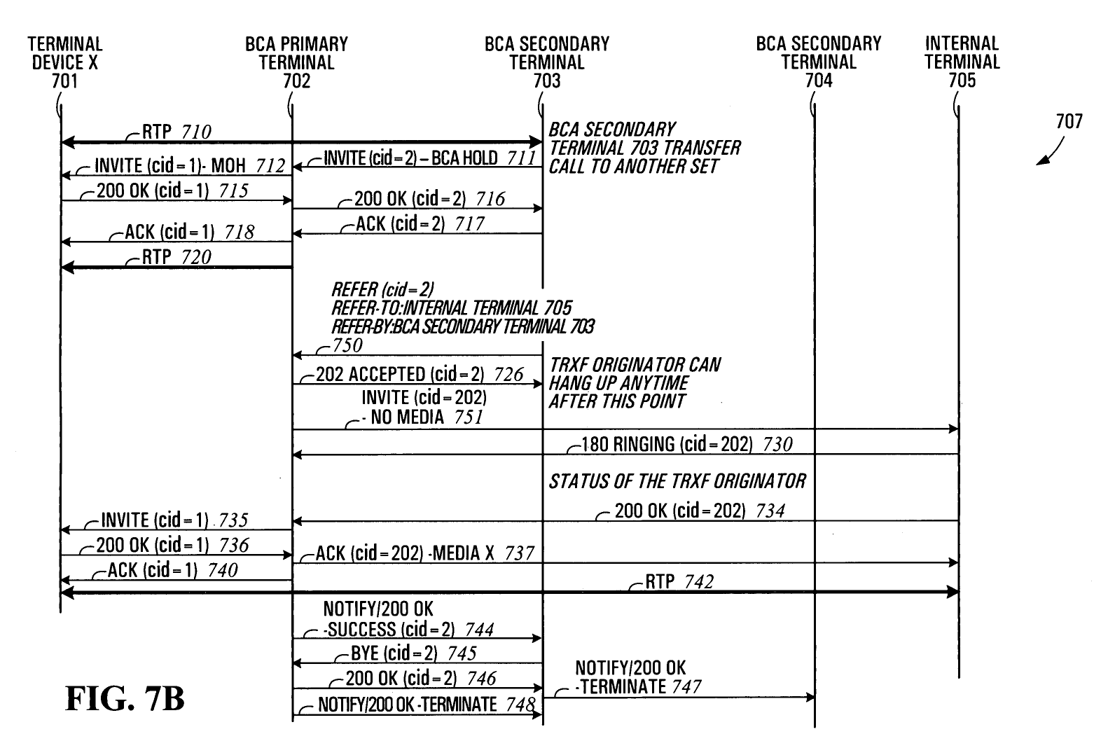

Referring to FIG. 8, an example of a signaling flow for an attended transfer call processing feature 800 from one terminal in the BCA Group to another terminal in the peer-to-peer network will now be described. The particular call processing feature 800 includes signal flow information pertaining to five terminals, Terminal Device X 801, BCA primary terminal 802, first BCA secondary terminal 803, second BCA secondary terminal 804 and internal terminal 805. In the example being described BCA secondary terminal 803 transfers a call to internal terminal 805.

Initial steps of an attended transfer call processing feature process 800 of FIG. 8, namely placing the call on hold, steps 810,811,812,815,816,817,818,820 and 821 are the same as steps 710,711,712,715,716,717,718,720 and 721 of the blind transfer call processing feature process 700 described above with respect to FIG. 7A. Following BCA secondary terminal 803 sending the “INVITE (cid=99)” request 821 to internal terminal 805, the internal terminal 805 sends a “180 Ringing/200 OK (cid=99)” response. 850 back to BCA secondary terminal 803. BCA secondary terminal 803 sends an acknowledgement 851 to internal terminal 805 in the form “ACK (cid=99)”. At this point in time a connection is established between BCA secondary terminal 803 and internal terminal 805, wherein information is transmitted 852 between the two terminals 803,805 using RTP. This connection allows the user of BCA secondary terminal 803 to introduce the user of the Terminal Device X 801 to the user of internal terminal 805. BCA secondary terminal 803 sends an “INVITE (cid=99)-hold” request 853 to internal terminal 805 and by way of response internal terminal 805 sends “200 OK (cid=99)” 854 to BCA secondary terminal 803. BCA secondary terminal 803 acknowledges the response with “ACK (cid=99)” 855. The remaining steps in FIG. 8 are the same as those in the embodiment of the blind transfer feature of FIG. 7A.

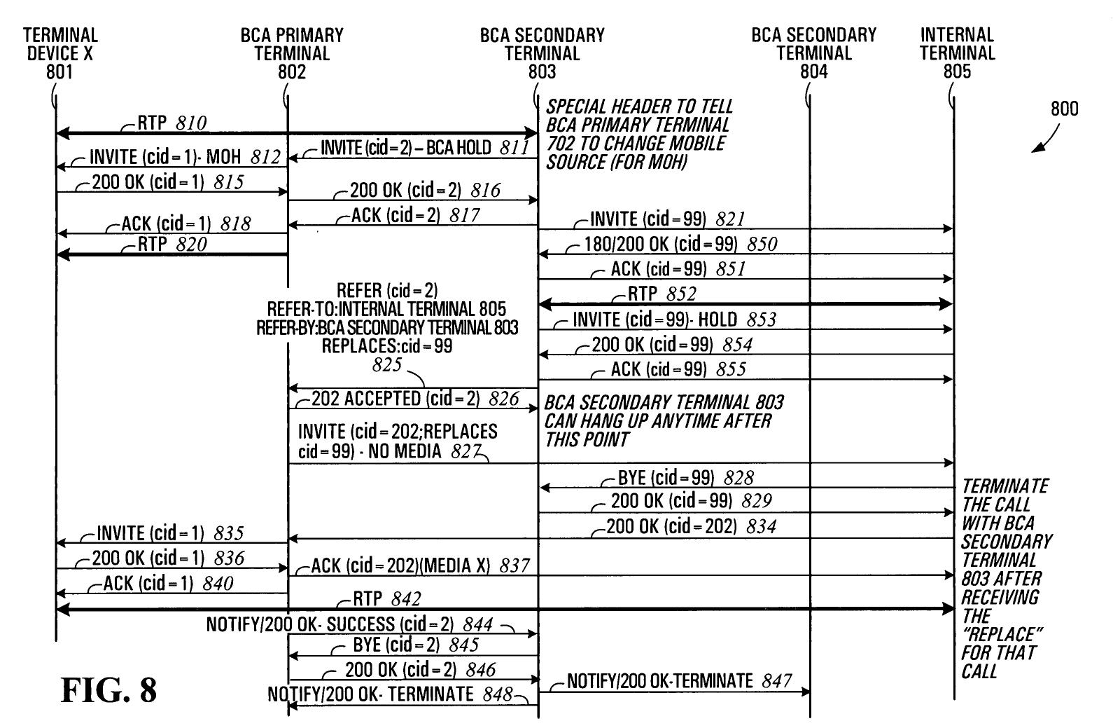

Referring to FIG. 9, an example of a signaling flow for an attended transfer call processing feature 900 from one terminal in the BCA Group to the BCA primary terminal will now be described. The particular call processing feature 900 includes signal flow information pertaining to five terminals, Terminal Device X 901, BCA primary terminal 902, first BCA secondary terminal 903, second BCA secondary terminal 904 and internal terminal 905. In the example being described BCA secondary terminal 903 transfers a call to BCA primary terminal 902.

Initial steps of an attended transfer feature process 900 of FIG. 9, namely placing the call on hold, steps 910,911,912,915,916,917,918,and 920 are the same as steps 810,811,812,815,816,817,818 and 820 of the attended transfer call processing feature 800 described above with respect to FIG. 8. Following BCA secondary terminal 903 sending an “ACK (cid=99)” 917 signal to primary terminal 902, BCA secondary terminal 903 also sends an “INVITE (cid=99)” request 921 to the BCA primary terminal 902. BCA primary terminal 902 sends BCA secondary terminal 903 a “180 Ringing/200 OK (cid=99)” response 950. BCA secondary terminal 903 sends an acknowledgement 951 to BCA primary terminal 902 in the form “ACK (cid=99)”. At this point in time a connection is established between BCA secondary terminal 903 and BCA primary terminal 902, wherein information is transmitted 952 between the two terminals 902,903 using RTP. This connection allows the user of BCA secondary terminal 903 to introduce the user of Terminal Device X 901 to the user of BCA primary terminal 902. BCA secondary terminal 903 sends an “INVITE (cid=99)-hold” request 953 to BCA primary terminal 902 and by way of response BCA primary terminal 902 sends “200 OK (cid=99)” 960 to BCA secondary terminal 903. BCA secondary terminal 903 acknowledges the response with “ACK (cid=99)” 955. BCA secondary terminal 903 sends a “REFER (cid=2)” message 962 to BCA primary terminal 902 including the information “Refer-to: BCA primary terminal 902”, “Refer-by: BCA secondary terminal 903” and “Replaces: cid=99”. In response to “REFER (cid=2)” 962 BCA primary terminal 902 sends a “202 Accepted (cid=2)” response 928. Based on the “REFER” message 962, BCA primary terminal 902 realizes it is being referred to a call that is local to itself. This means that call cid=1 should now terminate at BCA primary terminal 902. This results in BCA primary terminal 902 sending an “INVITE (cid=1)” request 935 to Terminal Device X 901 to which Terminal Device X 901 responds with a “200 OK (cid=1)” 936. BCA primary terminal 902 acknowledges the “200 OK (cid=1)” 936 with an “ACK (cid=1)” 940 sent to Terminal Device X 901. A connection is then established between Terminal Device X 901 and BCA primary terminal 902, wherein information is transmitted 942 between the two terminals 901,902 using RTP. The BCA primary terminal 902 also sends “Notify/200OK—Confirmed” 943,944 to the secondary terminals 903 and 904 notifying these terminals that BCA primary terminal 902 is now in a conversation. BCA primary terminal 902 sends “BYE (cid=99)” 970 to BCA primary terminal 903 terminating cal cid=99 and BCA primary terminal 903 responds to BCA secondary terminal 902 by sending “200 OK (cid=99)” 971. BCA primary terminal 902 further sends a “Notify/200 OK-Success” message 972 to BCA secondary terminal 903 notifying BCA secondary terminal 903 that the transfer of cid=99 has been successfully completed. Then BCA secondary terminal 903 responds by sending “BYE (cid=2)” 973 to BCA primary terminal 902 terminating call cid=2, whereby BCA primary terminal 902 sends back a “200 OK (cid=2) response 974.

The particular examples described above with respect to FIGS. 3-9 are shown being implemented with SIP. However, it is understood that other types of protocol signaling can be used to perform the signaling steps described above in the general examples of the BCA Group call processing features.

The use of RTP for communication between terminals in the various BCA Group call processing features is also noted to be one particular example of a protocol for such communication and it is to be understood that other protocols could be used for such communication in place of RTP.

The use of SDP for carrying media description between terminals in the various BCA Group call processing features is also noted to be one particular example of a protocol for such communication and it is to be understood that other protocols could be used for such communication in place of SDP.

An advantage of this type of BCA Group architecture is that Terminal Device X does not have to interact with multiple terminals within the peer-to-peer network. The use of the primary terminal as an intermediary allows Terminal Device X to interact with a single terminal for the sake of protocol signaling for initiating, maintaining and disconnecting from calls. As a result, terminals external to the peer-to-peer network can operate with any desired protocol and the BCA Group and/or peer-to-peer network can operate on the same protocol or a different and independent protocol for signaling between terminals of the peer-to-peer network. In some embodiments provided by the invention a protocol translator resides in any one of or all of the TTI, IPI, and/or the primary terminal of the BCA Group.

The signal flow charts described above are intended as examples of how call processing features may be implemented, in particular using SIP messaging. In some embodiments it may not be necessary to include all of the SIP commands or signals as described herein and in some embodiments there may be additional steps which are included to improve the BCA Group call processing features or add additional functionality to the features. It should also be understood that the ordering of steps as described herein are but examples of how the process may be implemented. Ordering of steps may have some deviation from those described above and still fall within the subject matter of the invention.

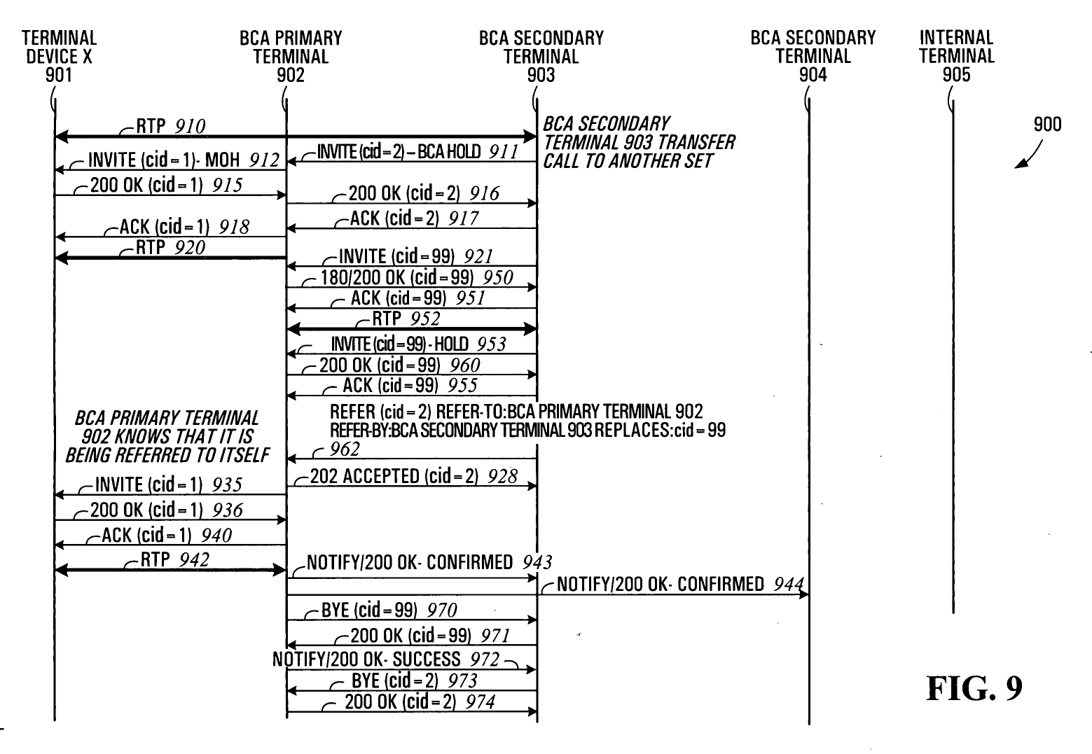

FIG. 10 shows a functional block diagram of software 1050 operating on terminal set 101 of FIG. 1. The software 1050 includes modules for performing particular functions, for example Bridge Call Appearance call processing features, as well a module for distributing information between the modules. The software 1050 will be described as operating on terminal set 101; however, it is to be understood that similar software is implemented in terminal sets 102, 103, 104, 105 and the terminal sets of FIG. 2. Furthermore, in some cases, at least some of the features of the software 1050 described below are implemented in any network device in the peer-to-peer network 20 including TTI 40 or IPI 50, for example. The software 1050 is stored in RAM and runs on a CPU, both also included in a terminal set such as terminal set 101 or other network devices such as TTI 40 or IPI 50. More generally, the software 1050 can be implemented as any suitable combination of instructions stored in memory for execution by general or special purpose processors, firmware, ASICs (Application Specific Integrated Circuits), FPGAs (Field-Programmable Gate Arrays), and general or special purpose logic. A system dispatcher 1000 provides communication and scheduling between various functional elements which include a call processing module 1005, a Bridge Call Appearance module 1010, a dialing rules module 1015, a peer discovery module 1020, a display handler 1025, an audio handler 1030, an input handler 1035, and a peer back-up module 1040. The call processing module 1005 also interfaces with a protocol stack 1045.

FIG. 10 shows a detailed example of functions that may be included in a network device such as terminal set 101, TTI 40 or IPI 50; however, it is to be understood that a network device need not have all of the functions shown in FIG. 10 and that in some implementations a network device will have only some of the functionality shown in FIG. 10. The display handler 1025 formats information and displays the information to a user. The input handler 1035 monitors inputs from for example key presses, hook switch, volume keys, and hands free and mute buttons and informs the system dispatcher 1000. The system dispatcher 1000 then distributes messages to other modules for further appropriate action to be taken. The audio handler 1030 plays audio tones such as ringing, busy, and call waiting tones and/or connects to a handset speaker or speaker phone through a media call upon receipt of an audio message from the system dispatcher 1000.

When terminal set 101 is initially connected to the network 30 it performs a peer discovery by executing the peer discovery module 1020. At this point terminal set 101 undergoes a discovery of peer network devices such as terminal sets 102, 103, 104, 105 and other network devices such as TTI 40 and IPI 50, by way of messages between terminal set 101 and terminal sets 102, 103, 104, 105, TTI 40 and IPI 50. Once the other terminal sets and network devices are discovered, information is exchanged between the terminal set 101 and the other terminal sets and network devices. In some embodiments, at least part of the information exchanged in the messages is included in a routing table.

In some implementations, a BCA primary network device such as a terminal set has one or more network device designated to serve as a backup BCA primary network device in the event that the BCA primary network device is unavailable to process a call. In particular, if a BCA primary network device is unavailable to process a call, the call is re-directed to one of its designated backup network devices and the designated backup network device receiving the re-directed call provides BCA and/or other types of call functionality for the BCA primary network device that is unavailable. In some embodiments, if the primary network device is unavailable and the secondary network devices registered with the primary network device are not available then the designated backup network device will not take over for the primary device. In some embodiments, the secondary network devices also have backup network devices.

On a more simplified level, each network device maintains an identification of designated backup network devices for itself and every other network device. In particular, when a new network device is added to the peer-to-peer network 20, the network device makes use of its peer discovery module 1020 to obtain routing information pertaining to other network devices in the peer-to-peer network 20 and makes use of the peer backup module 1040 to designate two other network devices as backup network devices.

Referring back to FIG. 10, the dialing rules module 1015 contains and/or applies a set of dialing rules for the call-processing module 1005, which control how calls are directed.

The call-processing module 1005 interacts with the protocol stack 1045 to set up and tear down calls, and to set up media calls.

The call processing modules of a number of network devices collectively serve to deliver PBX-like (Private Branch Exchange-like) call processing capabilities in a distributed fashion without the need for a PBX (Private Branch Exchange). For example, the call processing module 1005 of terminal set 101 handles calls not only intended for terminal set 101 but also handles calls for other network devices for which it has been designated as a backup terminal set. This allows the BCA module 1010 to perform the functions of a backup primary terminal when terminal set 101 has been so designated.

The BCA module 1010 is responsible for handling the BCA call processing features described above such as receiving an incoming call, placing an outgoing call, placing a call on hold, retrieving a call from hold, and blind or attended transfers. The BCA module contains computer readable program code for performing steps described above in the signaling flow diagrams for enabling the BCA call processing features in a distributed manner for a BCA Group comprised of a plurality of interconnected peer-to-peer packet-based network devices.

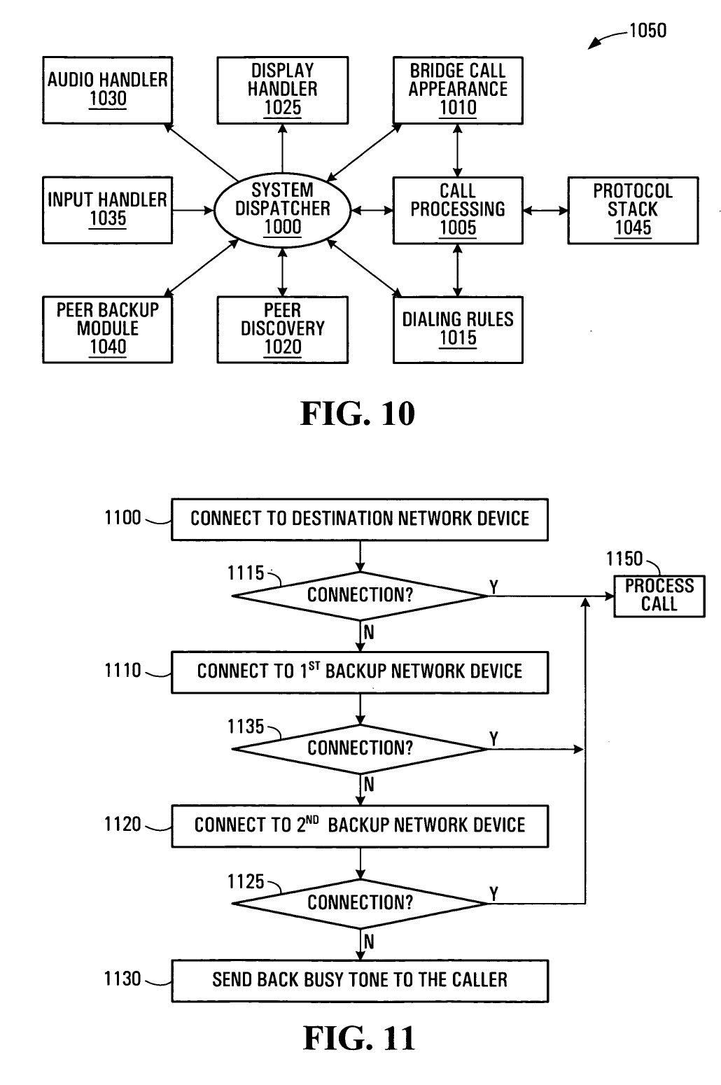

FIG. 11 shows a flow chart for a method of initiating a call from one network device to another network device, which might for example be employed in the peer-to-peer network 20 of FIG. 2. In particular, a caller at an originator network device wishes to call a person at a destination network device. At step 1100, the originator network device attempts to establish a connection for a call with the destination network device. At step 1105, if the connection is established (yes path) the call is processed normally (step 1150). At step 1105 if the attempt is unsuccessful, then the originator network device looks up its routing information to determine which network device is to serve as a first backup network device for the destination network device and to determine an address for the first backup network device. The attempt may be unsuccessful due to for example one or more of a network failure, a failure at the destination network device, the destination network device being unplugged or a lack of resources at the destination network device to process a call. In some cases, the lack of resources might be due to for example all call threads at the destination network device being used simultaneously. The originator network device then initiates a call to the first backup network device by attempting to establish a connection using the address of the first backup network device (step 1110). At step 1115, if the attempt is successful (yes path) and a connection is established with the first backup network device, the call is processed (step 1150). Again, the attempt at the connection with the first backup network device may be unsuccessful (no path) at step 1115 and if the attempt of step 1110 fails, then the originator network device looks up its routing information to determine which network device is to serve as a second backup network device for the destination network device and to determine an address for the second backup network device. The originator network device then initiates a call to the second backup network device by attempting to establish a connection using the address of the second backup network device (step 1120). At step 1125, if the attempt is successful (yes path) and a connection is established with the second backup network device, the call is processed (step 1150). If the attempt is unsuccessful (no path) then a busy indication is received by the originator network device to announce that no connection is possible at that time (step 1130).

Regarding processing at the destination network device, in one implementation at step 1150 the call is processed with a ringing signal being generated for answering of the call by a user of the BCA primary terminal or backup BCA primary terminals.

In a situation where the call is placed from a location outside the peer-to-peer network, TTI 40 or IPI 50 performs the actions of the originator network device described above. TTI 40 and IPI 50 maintain information in the same manner as the peer-to-peer terminals regarding which terminals are designated as primary terminal, secondary terminals, and back-up terminals for primary terminals. Therefore, when a call is originated outside the peer-to-peer network 20 the call enters the peer-to-peer network 20 through either TTI 40 or IPI 50. TTI 40 or IPI 50 then contacts the BCA primary terminal and if the BCA primary terminal is not connected to the network, then TTI 40 or IPI 50 looks up its routing information to determine which network device is to serve as a backup BCA primary terminal.

In the method of FIG. 11, each network device is assigned two other network devices as backup network devices and as such there are up to two attempts at establishing connections with network devices designated as backup network devices (steps 1110, 1120). More generally, a network device has M other network devices designated as backup network devices with M≧1 and successive attempts at establishing connections with the M backup network devices are performed until one of the attempts is successful. If none of the attempts are successful then a busy indication is sent back to the caller as described with reference to step 1130.

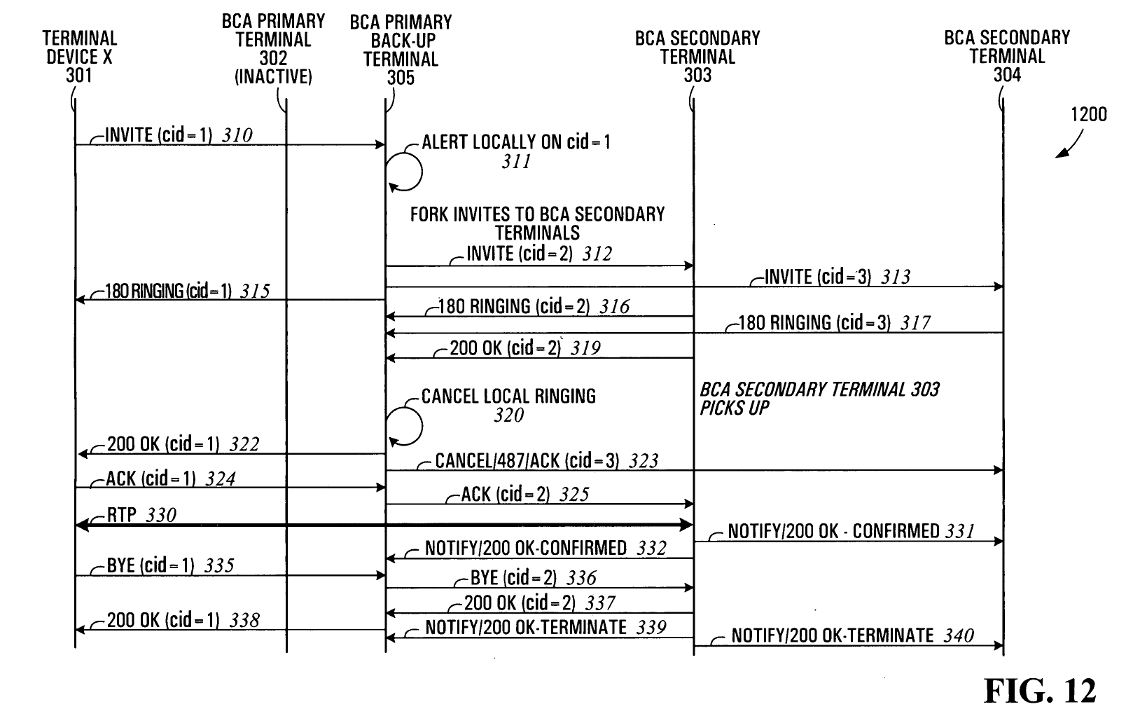

FIG. 12 illustrates the signal flow for an incoming call when it has been already determined that the BCA primary terminal 302 is inactive and a BCA primary back-up terminal 305 has been identified to perform the tasks of inactive BCA primary terminal 302. The steps of the call processing feature 1200 are the same as those for the call processing feature 300 in which the BCA primary terminal 302 was active, except that all protocol signaling is handled through BCA primary back-up terminal 305 instead of BCA primary terminal 302.

FIG. 12 illustrates an example of an incoming call to a back-up primary terminal. This is not to indicate that this is the only BCA call processing feature in which a backup primary terminal is used or needed. The principle of using a pre-designated backup primary terminal can apply to any of the BCA call processing features described above where appropriate.

In addition to BCA call processing features, other call processing functionality such as call forwarding, call park and pickup, call transfer, and paging, and other features such as time synchronization, backup features, and peer discovery, may be provided locally at network devices within a network. Such features and functionality are described in U.S. Provisional Patent Application No. 60/441,481 entitled “DISTRIBUTED PEER-TO-PEER CALL TRANSFER SYSTEM, METHOD AND TELEPHONE TERMINALS” and filed Jan. 22, 2003; U.S. Provisional Patent Application No. 60/441,121 entitled “DISTRIBUTED PEER-TO-PEER CALL FORWARDING SYSTEM, METHOD AND TELEPHONE TERMINAL” and filed Jan. 21, 2003; U.S. Provisional Patent Application No. 60/473,877 entitled “DISTRIBUTED PEER-TO-PEER CALL PARK AND CALL PARK PICKUP SYSTEM, METHOD AND TELEPHONE TERMINALS” filed May 29, 2003; U.S. Provisional Patent Application No. 60/518,646 entitled “PEER-TO-PEER DISCOVERY SYSTEM, METHOD AND NETWORK DEVICES” filed Nov. 12, 2003; U.S. Provisional Patent Application No. 60/523,703 entitled “PEER BACK-UP IN A DISTRIBUTED PEER-TO-PEER NETWORK: SYSTEM, METHOD AND NETWORK DEVICES” filed Nov. 21, 2003; U.S. Provisional Patent Application No. 60/523,140 entitled “TIME SYNCHRONIZATION OF NETWORK DEVICES IN A NETWORK: SYSTEM, METHOD AND NETWORK DEVICE” filed Nov. 19, 2003; and U.S. Provisional Patent Application No. 60/524,041 entitled “SYSTEM, METHOD AND NETWORK DEVICES FOR PAGING IN A NETWORK” filed Nov. 24, 2003, all of which are incorporated herein by reference. It is to be clearly understood that embodiments of the invention are also provided which only provide BCA call processing features.

Numerous modifications and variations of the present invention are possible in light of the above teachings. It is therefore to be understood that within the scope of the appended claims, the invention may be practised otherwise than as specifically described herein.

1. A Bridge Call Appearance (BCA) Group comprising a plurality of interconnected peer-to-peer packet-based network devices adapted to collectively implement BCA call processing features in a distributed manner.

2. The BCA Group of claim 1, wherein the BCA call processing features comprise at least one of a group consisting of answering incoming calls, placing outgoing calls, placing a call on hold, retrieving a call from hold, performing a blind transfer, and performing an attended transfer.

3. The BCA Group of claim 1, wherein at least one peer-to-peer packet-based network device of the plurality of interconnected peer-to-peer packet-based network devices is designated as a primary network device and remaining peer-to-peer packet-based network devices are designated as secondary network devices, the secondary network devices adapted to provide support for the primary network device when the primary network device is unavailable;
wherein the primary network device is adapted to act as an intermediary for protocol signaling involving a secondary network device in the BCA Group and an other device with which the secondary network device in the BCA Group is communicating.

4. The BCA Group of claim 3, wherein communication data is exchanged between the secondary network device in the BCA Group and the other device subsequent to establishing a network device-to-device connection, the primary network device remaining in contact with the secondary network device and the other device to facilitate further protocol signaling as the intermediary between the secondary network device in the BCA Group and the other device.

5. The BCA Group of claim 3, wherein communication data flows between the secondary network device in the BCA Group and the other device subsequent to establishing a network device-to-device connection in accordance with Real-time Transport Protocol (RTP).

6. The BCA Group of claim 3, wherein protocol signaling is performed in accordance with Session Initiation Protocol (SIP).

7. The BCA Group of claim 3, wherein the other device is a peer-to-peer packet-based network device internal to the BCA Group.

8. The BCA Group of claim 3, wherein the other device is external to the BCA Group.

9. The BCA Group of claim 3, wherein the primary network device and the secondary network devices are Voice over Internet Protocol (VoIP) telephone terminal sets.

10. The BCA Group of claim 3, wherein the primary network device and the secondary network devices are packet-based communication telephone terminal sets.

11. The BCA Group of claim 3, wherein the primary network device is designated as a secondary network device for a second primary network device in the BCA Group.

12. The BCA Group of claim 3, wherein the primary network device is assigned at least one backup primary network device and when the primary network device is not connected within the BCA Group, the at least one backup primary network device performs tasks that the primary network device would have performed if the primary network device was connected within the BCA Group.

13. A peer-to-peer system comprising:
at least one BCA Group according to claim 1, wherein at least one peer-to-peer packet-based network device is designated as a primary network device and remaining peer-to-peer packet-based network devices are designated as secondary network devices, the secondary network devices adapted to provide support for the primary network device when the primary network device is unavailable; and
at least one access interface coupled to the at least one BCA Group, the at least one access interface providing access to communication networks external to the peer-to peer system.

14. The system of claim 13, wherein the at least one access interface is a thin trunk interface (TTI) for connecting peer-to-peer packet-based network devices of the at least one BCA Group to a public switched telephone network (PSTN) external to the peer-to-peer system.

15. The system of claim 13, wherein the at least one access interface is an interface for connecting peer-to-peer packet-based network devices of the at least one BCA Group within the peer-to-peer system to a packet-based network external to the peer-to-peer system.

16. The system of claim 13, wherein the primary network device and the secondary network devices are VoIP terminal sets.

17. A method for operation of a BCA Group comprising a plurality of interconnected peer-to-peer packet-based network devices wherein at least one peer-to-peer packet-based network device is designated as a primary network device and remaining peer-to-peer packet-based network devices are designated as secondary network devices, the primary network device adapted to act as an intermediary for protocol signaling involving a secondary network device in the BCA Group and an other device with which the secondary network device in the BCA Group is communicating, the method comprising:
collectively implementing BCA call processing features in a distributed manner.

18. The method of claim 17, wherein the call processing feature is receiving an incoming call, the method comprising:
a calling device contacting the primary network device;
the primary network device contacting the secondary network devices with notification of contact of the calling device;
a first secondary network device responding to the contact of the primary network device;
the primary network device arranging a connection between the calling device and the first secondary network device via protocol signaling;
upon completion of a communication session over the connection between the calling device and the first secondary network device, terminating contact between the calling device and the primary network device and the primary network device terminating contact with the first secondary network device; and
the first secondary network device notifying all network devices that the first secondary network device is currently idle.

19. The method of claim 17, wherein the call processing feature is placing an outgoing call, the method comprising:
the primary network device contacting the secondary network devices prior to contacting a called device to notify the secondary network devices of a possible communication session between the primary network device and the called device;
the primary network device contacting the called device;
the called device responding to the contact of the primary network device;
the primary network device arranging a connection between the called device and the primary network device via protocol signaling;
the primary network device contacting the secondary network devices to notify the secondary network devices that the primary network device is currently busy;
upon completion of a communication session over the connection between the primary network device and the called device, terminating contact between the primary network device and the called device; and
the primary network device notifying the secondary network devices that the primary network device is currently idle.

20. The method of claim 17, wherein the call processing feature is placing a call on hold, wherein a first secondary network device and an other device are currently engaged in a communication session, the method comprising:
the first secondary network device placing a call with the other device on hold;
the first secondary network device handing over control of the call on hold to the primary network device;
the primary network device terminating contact with the first secondary network device; and
the first secondary network device notifying the secondary network devices of the location and status of the call.

21. The method of claim 20, wherein control of the call on hold includes any one of a group consisting of supplying music for the other device on hold and supplying voice messages for the other device on hold.

22. The method of claim 17, wherein the call processing feature is retrieving a call from hold, wherein the call is currently on hold between the primary network device and an other device, the method comprising:
a first secondary network device initiating retrieving the call on hold from the primary network device;
the primary network device arranging a connection between the first secondary network device and the other device via protocol signaling between the primary network device and the other device and between the primary network device and the first secondary network device;
upon completion of a communication session between a user of the other device and a user of the first secondary network device, terminating contact between the other device and the primary network device and the primary network device terminating contact with the first secondary network device; and
after the primary network device terminates contact with the first secondary network device, the first secondary network device notifying all peer-to-peer packet-based network devices that the first secondary network device has completed its involvement with the retrieving the call from hold call processing feature and contact between the first secondary network device and other devices has been terminated and the first secondary network device is currently idle.

23. The method of claim 22, further comprising:
the primary network device terminating contact with a peer-to-peer packet-based network device that originally placed the call on hold; and
following the first secondary network device being connected to the other device, the first secondary network device informing the primary network device and secondary network devices that the first secondary network device has successfully picked up the hold.

24. The method of claim 17, wherein the call processing feature is a blind transfer to a peer-to-peer packet-based network device within a peer-to-peer system comprising at least the BCA Group, wherein a first secondary network device and an other device are currently engaged in a communication session, the method comprising:
the first secondary network device initiating transferring of a call from the other device to a transfer receiving network device;
the first secondary network device placing the call on hold and handing over control of the call on hold to the primary network device;
the first secondary network device contacting the primary network device to have the primary network device contact the transfer receiving network device;
the primary network device contacting the transfer receiving network device and inviting the transfer receiving network device to accept the call from the other device currently on hold;
the transfer receiving network device accepting the call;
the primary network device arranging a connection between the other device and the transfer receiving network device via protocol signaling;
upon connection of the other device and the transfer receiving network device, the primary network device terminating contact with the first secondary network device;
after the primary network device terminates contact with the first secondary network device, the first secondary network device notifying all peer-to-peer packet-based network devices that the first secondary network device has completed its involvement with the blind transfer call processing feature and contact between the first secondary network device and other devices has been terminated and the first secondary network device is currently idle.

25. The method of claim 17, wherein the call processing feature is an attended transfer to peer-to-peer packet-based network device within a peer-to-peer system comprising at least the BCA Group, wherein a first secondary network device and an other device are currently engaged in a communication session, the method comprising:
the first secondary network device initiating transferring of a call from the other device to a transfer receiving network device;
the first secondary network device placing the call on hold and handing over control of the call on hold to the primary network device;
the first secondary network device contacting the transfer receiving network device and the user of the first secondary network device introducing the call to the user of the transfer receiving network device;
the first secondary network device placing the call with the transfer receiving network device on hold;
the first secondary network device contacting the primary network device, passing control of the call with the transfer receiving network device currently on hold and having the primary network device arrange connecting the calls currently on hold;
the primary network device contacting the transfer receiving network device and inviting the transfer receiving network device to accept the call from the other device currently on hold;
the transfer receiving network device accepting the call;
the primary network device arranging a connection between the caller device and the transfer receiving network device via protocol signaling;
upon connection of the caller device and the transfer receiving network device, the primary network device terminating contact with the first secondary network device; and
after the primary network device terminates contact with the first secondary network device, the first secondary network device notifying all peer-to-peer packet-based network devices that the first secondary network device has completed its involvement with the attended transfer call processing feature and contact between the first secondary network device and other devices has been terminated and the first secondary network device is currently idle.

26. The method of claim 17, wherein the primary network device and the secondary network devices are VoIP terminal sets.

27. The method of claim 17, wherein the primary network device is assigned at least one backup primary network device and when the primary network device is not connected within the BCA Group, the at least one backup primary network device performs tasks of the primary network device that would have been performed by the primary network device if the primary network device was connected within the BCA Group.

28. The method of claim 18, wherein when the calling device cannot contact the primary network device, a backup primary network device that is known to be assigned to the primary network device is contacted to perform tasks that would have otherwise been performed by the primary network device if the primary network was available for contact by the calling device.

29. A communication system comprising:
a peer-to-peer network comprising;
at least one BCA Group of claim 1, wherein a peer-to-peer packet-based network device is designated as a primary network device and remaining peer-to-peer packet-based network devices are designated as secondary network devices, the secondary network devices adapted to provide support for the primary network device when the primary network device is unavailable; and
at least one access interface coupled to the at least one BCA Group, the at least one access interface providing access to communication networks external to the peer-to peer system; and
at least one communication network external to the peer-to-peer network coupled to the peer-to-peer network via the at least one access interface;
wherein the primary network device of the BCA Group acts as an intermediary for communication involving a secondary network device in the BCA Group and an other device with which the secondary network device in the BCA Group is communicating, wherein protocol signaling for establishing a network device-to-device connection between the other device and the secondary network device in the BCA Group is transmitted via the primary network device.

30. The communication system of claim 29, wherein the primary network device is assigned at least one backup primary network device and when the primary network device is not connected within the BCA Group, the at least one backup primary network device performs tasks of the primary network device that would have been performed by the primary network device if the primary network device was connected within the BCA Group

31. A VoIP terminal set for use in the BCA Group of claim 1.

32. A computer usable medium for use in a peer-to-peer packet-based network device having computer readable program code means embodied therein, the computer readable program code means for implementing BCA call processing features in a distributed manner for a BCA Group comprising a plurality of interconnected peer-to-peer packet-based network devices each equipped with the computer readable program code means.

33. The computer usable medium of claim 32, further comprising computer readable program code means for assigning at least one backup primary network device to a primary network device and when the primary network device is not connected within the BCA Group, the computer readable program code performing tasks of the primary network device that would have been performed by the primary network device if the primary network device was connected within the BCA Group.
